(19) United States
(12) Patent Application Publication
(10) Pub. No.: US 2026/0285436 A1
(43) Pub. Date: Sep. 24, 2026

(54) MOBILITY VEHICLE

(71) Applicant: Pride Mobility Products Corporation, Duryea, PA (US)

(72) Inventors: Rock David MAGNOTTA, Scranton, PA (US); Nicholas E. KUZMA, Dallas, PA (US); Anthony LETUKAS, Dallas, PA (US)

(21) Appl. No.: 19/168,507

(22) PCT Filed: Mar. 29, 2024
(86) PCT No.: PCT/US2024/022238

§ 371 Date: Sep. 24, 2025

Related U.S. Application Data
(60) Provisional application No. 63/492,966, filed on Mar. 29, 2023.

(51) Int. Cl. B62K 5/08; B60K 1/00; B62D 7/09; B62D 15/02; B62K 5/007

(52) U.S. Cl. CPC B62K 5/08; B62D 7/09; B62D 15/0215; B62K 5/007; B60K 2001/001

(57) ABSTRACT

A mobility scooter comprises a frame, a drive wheel and a steering assembly. The drive wheel is coupled to the frame and rotatable about a drive wheel axis. The steering assembly is coupled to the frame and includes a steering stem having a stem axis, the steering stem rotatable about the stem axis in response to input from a steering input, a front inside wheel, a steering stop, and a tie rod. The tie rod is pivotably coupled to the steering stem at a first end and pivotably coupled to a steering arm at a second end, and pivots in response to movement of the steering input to engage the steering stop when the front inside wheel reaches a maximum outward turn angle to prevent said front inside wheel from being turned beyond the maximum outward turn angle.

### CROSS-REFERENCE TO RELATED APPLICATIONS

This application claims the benefit of U.S. Provisional Patent Application No. 63/492,970 filed Mar. 29, 2023 entitled “Mobility Vehicle”, which is incorporated by reference herein in its entirety.

### TECHNICAL FIELD

The present application generally relates to a mobility vehicle and, more particularly, to a steering assembly and a control system for a mobility vehicle.

### BACKGROUND

There has been a dramatic increase in popularity of personal mobility vehicles over the last several decades. This increase is due to many factors including the advent of new structural techniques and materials, as well as an aging population. There is also an increased use of the mobility vehicles indoors and in crowded environments. With such use, there is an increased need for personal mobility vehicles with a turning radius, stability and simplicity to accommodate an aging population.

In addition to improving the radius of turn, there is also a need for vehicles with better handling entering or exiting a tight turn. For example, if a driver attempts to enter a tight turn with a personal mobility vehicle at too high of a speed, the vehicle may become unstable. The vehicle may also skid in the direction of its forward momentum and the driver will lose control of the vehicle. This is referred to as understeering, or plowing. Another problem exists when a driver attempts to exit a tight turn. Specifically, if a driver attempts to exit a tight turn too quickly and at too high of a speed, the vehicle may oversteer, or tend to continue in the direction of the turn. A problem that has inhibited broad access to personal mobility vehicles with improved handling entering and exiting a tight turn is the cost. Traditionally, these vehicles have been assembled using multiple sensors and multiple motors controlling the rear wheels, which can be costly to manufacture and maintain.

Three wheeled vehicles, vehicles with a single steering wheel and two rear drive wheels, may be configured to have a tight turning radius but may be considered unstable without mitigating configurations controls or designs. Vehicles with two closely spaced directional control wheels that share a common axis while turning may also have similar stability concerns as three wheeled vehicles.

As disclosed in some embodiments herein, adding an additional steerable front wheel may result in a more stable vehicle. In some embodiments, by configuring the vehicle as described herein, the four wheeled vehicle may have tight radius turning capabilities that are at least as effective as a three wheeled vehicle, with an increase in stability over a three wheeled vehicle.

There is thus disclosed herein exemplary vehicles with a steering configuration and a control system configured to improve turning radius and/or steering functionality while maintaining a desired level of stability.

### SUMMARY

In certain embodiments, a personal mobility vehicle is disclosed. In certain embodiments, the personal mobility vehicle comprising a frame having a longitudinal axis; a drive wheel rotatably coupled to the frame about a drive axle; a drive motor coupled to the frame and the drive wheel; a controller configured to cause the drive motor to drive the drive wheel; and a steering assembly. In certain embodiments, the steering assembly is coupled to the frame. In certain embodiments, the steering assembly including: a wheel having a rotation axis and a pivot axis; a pivotable steering input configured to pivot the wheel about the pivot axis; a steering position sensor configured to detect a pivot position of the steering input relative to the frame; and a kingpin coupled to the frame, the kingpin having a kingpin axis at a camber angle of approximately 4 degrees and a spindle along the rotation axis at a caster angle of approximately 5 degrees. In certain embodiments, the personal mobility vehicle is configured to produce a front axle rear axle axis trace area of approximately 177.62 ft².

In certain embodiments, a wheelbase is less than 3 feet. In certain embodiments, the steering assembly further comprises: a single hall effect sensor; and a left target and a right target configured to be sensed by the hall effect sensor to indicate that steering input has attained an angle relative to the longitudinal axis of about 35 degrees. In certain embodiments, the controller is configured cause the drive motor to rotate the drive wheel at a maximum speed only when the steering input is positioned at an angle of less than 35 degrees off the longitudinal axis. In certain embodiments, the controller is configured cause the drive motor to restrict rotation of the drive wheel to less than a maximum speed when the steering input is positioned in at an angle of at least 35 degrees off the longitudinal axis.

In certain embodiments, the steering assembly includes a steering stem rotatable about a steering axis, the steering stem including two spaced apart targets separately detectable by a sensor coupled to the frame based on a rotation position of the steering stem. In certain embodiments, the wheel is rotatable about an axle disposed along the rotation axis that is fixed relative to a steering arm projecting from the kingpin, the steering arm and axle defining an angle of from 70 degrees to 75 degrees. In certain embodiments, the mobility vehicle is configured and dimensioned to produce a minimum turning radius to wheel base ratio of from 1 to 1.3. In certain embodiments, an intermediate maximum outward turn angle of the wheel is different from a maximum outward turn angle of the wheel by approximately 10 degrees. In certain embodiments, a motor drives a transaxle about which the drive wheels rotate.

In certain embodiments, the steering assembly includes two front wheels each pivotable about a respective kingpin axis and rotatable about a wheel axis and wherein a trace produced by a point of intersection of each wheel axis as the front wheels pivot about their respective kingpin axes defines the trace area. In certain embodiments, the trace intersects with a lowermost tangent perpendicular to the longitudinal axis at a point that is: i) at least 12 track widths from the longitudinal axis, ii) between 12 track widths and 28 track widths from the longitudinal axis; or iii) from about 30 feet to about 50 feet from the longitudinal axis. In certain embodiments, the drive wheel rotates about a drive wheel axis and the trace includes a sensor-on location that is approximately 42 inches below the drive wheel axis.

In certain embodiments, a mobility scooter is disclosed. In certain embodiments, the mobility scooter comprising: a frame; a drive wheel coupled to the frame and rotatable about a drive wheel axis; and a steering assembly, coupled to the frame. In certain embodiments, the steering assembly includes: a steering stem having a stem axis, the steering stem rotatable about the stem axis in response to input from a steering input; a front inside wheel, a steering stop, and a tie rod, pivotably coupled to the steering stem at a first end and pivotably coupled to a steering arm at a second end, and configured to pivot in response to movement of the steering input and to engage the steering stop when the front inside wheel reaches a maximum outward turn angle to prevent said front inside wheel from being turned beyond the maximum outward turn angle. In certain embodiments, the steering stop engages the tie rod a first distance from the first end of the tie rod and a second distance from the second end of the tie rod. In certain embodiments, a ratio of the first distance to second distance is at least 1.75:1.

In certain embodiments, a mobility scooter is disclosed. In certain embodiments, the mobility scooter comprising: a frame; a drive wheel coupled to the frame and rotatable about a drive wheel axis; and a steering assembly, coupled to the frame. In certain embodiments, the steering assembly includes: a steering stem having a stem axis, the steering stem rotatable about the stem axis in response to input from a steering input; a front inside wheel pivotable relative to the frame about a kingpin, a steering stop, and a tie rod, pivotably coupled to the steering stem at a first end and pivotably coupled to a steering arm at a second end, and configured to pivot in response to movement of the steering input and to engage the steering stop when the front inside wheel reaches a maximum outward turn angle to prevent said front inside wheel from being turned beyond the maximum outward turn angle. In certain embodiments, an axis of the tie rod and an axis extending from the second end of the tie rod through the kingpin forms an angle Y. In certain embodiments, the angle Y is less than 22 degrees.

In certain embodiments, a mobility scooter is disclosed. In certain embodiments, the mobility scooter comprising: a frame; a drive wheel coupled to the frame and rotatable about a drive wheel axis; and a steering assembly, coupled to the frame. In certain embodiments, the steering assembly includes: a steering stem having a stem axis, the steering stem rotatable about the stem axis in response to input from a steering input; a steering position sensor configured to detect a position of the steering stem when the steering stem is rotated a first angle about the stem axis; a controller configured to process a signal from the steering sensor; a front inside wheel pivotable relative to the frame about a kingpin; a steering stop, and a tie rod, pivotably coupled to the steering stem and configured to pivot in response to movement of the steering stem and to engage the steering stop when the steering stem is rotated a second angle about the stem axis to prevent said front inside wheel from being turned beyond a maximum outward turn angle. In certain embodiments, the second angle is between 5 -25 degrees greater than the first angle.

### BRIEF DESCRIPTION OF THE DRAWINGS

The foregoing summary, as well as the following detailed description of embodiments of the Mobility Vehicle, will be better understood when read in conjunction with the appended drawings of an exemplary embodiment. It should be understood, however, that the invention is not limited to the precise arrangements and instrumentalities shown.

In the drawings:

FIGS. 1A-1C are a side elevational view, top plan view, and front elevational view, respectively, of a vehicle in accordance with at least one embodiment of the invention;

FIG. 2 is a bottom plan view of a vehicle in accordance with at least one embodiment of the invention;

FIGS. 3A, 3B are a front perspective view of a front portion of the vehicle showing an exemplary steering position sensor system in accordance with at least one embodiment of the invention;

FIG. 4A is a schematic top view of an exemplary steering position sensor configuration in accordance with at least one embodiment of the invention;

FIG. 4B is a schematic top view of an exemplary steering position sensor configuration in accordance with at least one embodiment of the invention;

FIG. 5A is a schematic top view of an exemplary steering input and steering position sensor configuration in accordance with at least one embodiment of the invention;

FIG. 5B is a schematic top view of an exemplary steering input and steering position sensor configuration in accordance with at least one embodiment of the invention;

FIG. 6A is a top plan view of the vehicle in a minor-turn position in accordance with at least one embodiment of the invention;

FIG. 6B is a top plan view of the vehicle in a major-turn position in accordance with at least one embodiment of the invention;

FIG. 7 is a schematic representation of the vehicle in a minor-turn position and a max-turn position in accordance with at least one embodiment of the invention;

FIG. 8A is a flow chart illustrating functionality for determining whether a vehicle meets major-turn entering criteria, according to some embodiments of the invention;

FIG. 8B is a schematic representation of vehicle illustrating exemplary major-turn entering functionality of FIG. 8A, according to some embodiments of the invention;

FIG. 9A1 is a partial bottom front perspective view of the vehicle showing the front portion in accordance with at least one embodiment of the invention;

FIG. 9A2 is a top plan view of the vehicle in a max-turn position in accordance with at least one embodiment of the invention;

FIG. 9B1 is a partial top plan view of the vehicle showing the front portion in a minor-turn position according to some embodiments of the invention;

FIG. 9B2 is a partial top plan view of the vehicle showing the front portion in a max-turn position according to some embodiments of the invention;

FIG. 9B3 is a schematic top view of an exemplary stem tab in accordance with at least one embodiment of the invention;

FIG. 9C1 is a partial top front perspective view of the vehicle showing the front portion in accordance with at least one embodiment of the invention;

FIG. 9C2 is a partial top plan view of the vehicle showing the axle beam in accordance with at least one embodiment of the invention;

FIG. 9C3 is a partial front view of the vehicle showing the axle beam in accordance with at least one embodiment of the invention;

FIG. 9C4 is a partial top plan view of the vehicle showing the kingpin in accordance with at least one embodiment of the invention;

FIG. 9D is a partial front view of the vehicle showing the axle beam in accordance with at least one embodiment of the invention;

FIG. 9E is a partial side view of the vehicle showing the kingpin in accordance with at least one embodiment of the invention;

FIG. 9F is a top plan view of the vehicle in a max-turn position in accordance with at least one embodiment of the invention;

FIG. 10 is a schematic representation of a turn radius of the vehicle while operating in a max-turn position, according to some embodiments of the invention;

FIG. 11 is a bottom plan view of the vehicle in a max-turn position in accordance with at least one embodiment of the invention;

FIG. 12 is a schematic representation of a trace reflecting intersection of the front wheel axes throughout pivot of the steering assembly in accordance with at least one embodiment of the invention;

FIG. 13A is a is a partial top plan view of the vehicle showing the steering assembly in accordance with at least one embodiment of the invention;

FIG. 13B is a is a partial top plan view of the vehicle showing a portion of the steering assembly in accordance with at least one embodiment of the invention; and

FIG. 14 is a is a partial top plan view of the vehicle showing the steering assembly in accordance with at least one embodiment of the invention.

### DETAILED DESCRIPTION

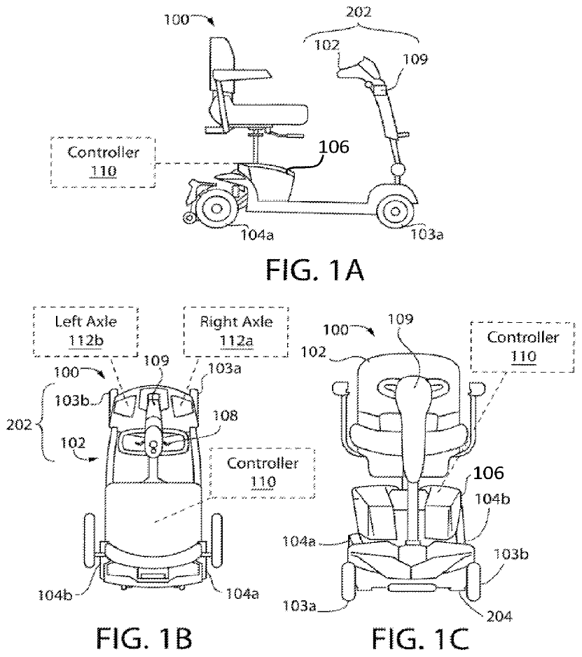

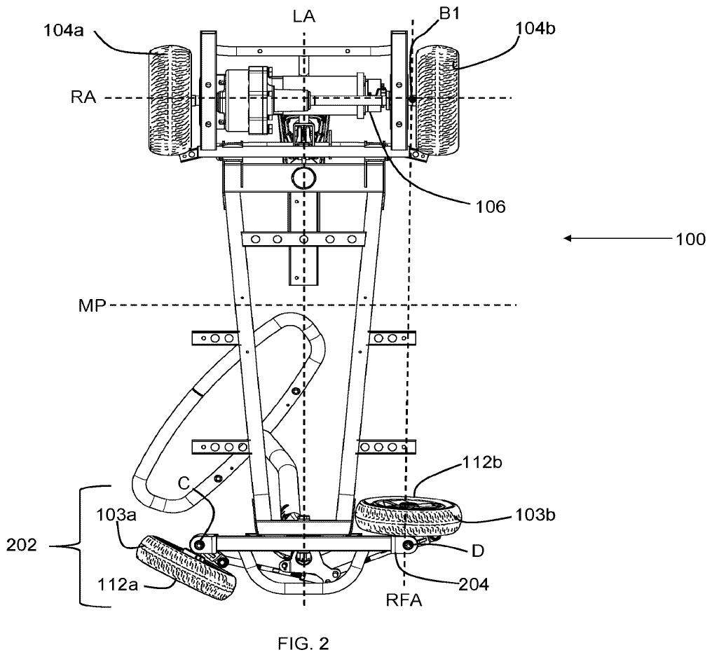

Referring to the drawings in detail, wherein like reference numerals indicate like elements throughout, there is shown in FIGS. 1A-14 a vehicle 100 in accordance with an exemplary embodiment of the present invention.

Referring to FIGS. 1A-1C and 2, in some embodiments, the vehicle 100 includes a steering assembly 202 configured to steer the at least one front directional control wheel (e.g., right and left front wheels 103a, 103b) of the vehicle 100 based on an input from the user. While FIGS. 1A-1C and 2 show two directional control wheels (that are steerable), in some embodiments, the vehicle 100 may include one directional control wheel, one directional control wheel with a caster wheel, or three directional control wheels. The steering assembly 202 may include a steering input 102, and a linkage to couple the right and left directional control wheels 103a, 103b to one another and to the steering input 102. In response to detecting movement (e.g., rotation) of steering input 102, the steering assembly 202 causes the right and left directional control wheels 103a, 103b to reorient in different configurations. As a result, a user can control the right and left directional control wheels 103a, 103b via rotation of the steering input 102.

In the example shown in FIGS. 1A-1C, the steering input 102 (e.g., a tiller) that a user grasps and steers or turns, about a generally vertical axis. In some embodiments, the steering input 102 includes a steering wheel, foot pedals, cable pulls, hand paddles, levers, switches and/or buttons to control the steering direction of the vehicle 100. The steering input 102 may be coupled to a right directional control wheel 103a and a left directional control wheel 103b as described, for example, in further detail below. Movement (e.g., rotation) of the steering input 102, as performed by a user, causes the right and left directional control wheels 103a, 103b to reorient (e.g., rotate) in a similar direction, thereby allowing a user to steer the vehicle 100. In one embodiment, by including two directional control wheels 103a, 103b, for a total of four total wheels, the vehicle 100 has increased stability as compared to a vehicle having one directional control wheel, for a total of three wheels (or five wheels where the vehicle includes two caster front wheels for stability).

As shown in FIG. 1B and FIG. 2, the steering input 102 may be pivotably coupled to the right directional control wheel 103a via one or more linkages 204 and the steering input 102 may be coupled to the left directional control wheel 103b via one or more linkages 204 as described in further detail below. The right directional control wheel 103a pivots about right wheel axle 112a and the left directional control wheel 103b pivots about left wheel axle 112b. In some embodiments, the right wheel axle 112a is moveable independent of the left wheel axle 112b, such that the right wheel axle 112a pivots about a different axis than the left wheel axle 112b as the vehicle turns. In one embodiment, the right wheel axle 112a is collinear with the left wheel axle 112b when the vehicle is going straight and then the right axle 112a is non-collinear with left wheel axle 112b when the vehicle is turning left or right. In some embodiments, the right and left front wheels 103a, 103b are each laterally spaced from the longitudinal axis LA by an approximately equal distance.

In some embodiments, by orienting the right and left control wheels 103a, 103b and driving the right and left drive wheels 104a, 104b, the turning radius of the vehicle 100 is decreased. The maximum turn, or minimum turning radius, of the vehicle may be referred to as a max-turn. The maximum turn of the tiller, or maximum turn input of the steering assembly, may be referred to as the max-turn position. In some embodiments, vehicle 100 may be operated in a major-turn mode which refers to a mode where vehicle 100 is commanded to run above a threshold steering angle. Max-turn mode may be characterized by a maximum commanded turn angle that exceeds the commanded major-turn mode angle. In such a case, the max-turn mode is a subset of the major-turn mode (and, as such, in some cases here these may be used interchangeable where the distinction is not important to an understanding of the invention).

In FIG. 2, the steering input 102 of the vehicle 100 is in an exemplary major-turn position, such as where the steering input 102 is fully rotated in a clock-wise or counter-clock-wise direction. As a result of the steering input 102 of the vehicle 100 being in a max-turn position, the steering assembly 202 causes one of the right and left directional control wheels 103a, 103b to reorient in a direction parallel to the lateral axis MP of the vehicle 100. In some embodiments, the lateral axis MP extends from side to side of the vehicle 100 and is perpendicular to the longitudinal axis LA. This orientation, where one of the right and left directional control wheels 103a, 103b are reoriented in a direction substantially parallel to the lateral axis MP may allow the vehicle 100 to perform a major-turn. In one embodiment, the vehicle 100, while in a major-turn, rotates about a vertical axis B1. In some embodiments, the vertical axis B1 may intersect the rear wheel axis RA and an inside directional control wheel rotational axis (e.g., left front axis LFA of left directional control wheel 103a), at a point outside the inside drive wheel 104b, as discussed in further detail below.

The steering assembly 202 may be coupled to the right directional control wheel 103a via a right wheel axle 112a and may be coupled to the left directional control wheel 103b via a left wheel axle 112b. In some embodiments, the right wheel axle 112a pivots about a second axis C, and the left wheel axle 112b pivots about a third axis D, separate and distinct from the second axis C. In one embodiment, the right directional control wheel 103a and the left directional control wheel 103b share a common axle and axis (not shown). In one embodiment, only a single front wheel is provided.

In some embodiments, the vehicle 100 includes a right drive wheel 104a and a left drive wheel 104b. The right drive wheel 104a and left drive wheel 104b may be configured to drive the vehicle 100 while in operation. In some embodiments, the right and left drive wheels 104a, 104b are each laterally spaced from the longitudinal axis LA by an approximately equal distance.

In some embodiments, the vehicle 100 includes a motor 106 coupled to the right and left drive wheels 104a, 104b. The motor 106 a may be configured to drive the right and left drive wheels 104a, 104b while in operation. The motor 106 may be configured to drive the right and left drive wheels 104a, 104b in the forward or rearward direction as discussed in further detail below.

In some embodiments, the vehicle 100 includes a user speed input device or throttle 108 controllable by a user and configured to receive a speed input from a user to control the speed of the vehicle 100. In some embodiments, the throttle 108 is a lever, such as shown, configured to be squeezed by the user. In one embodiment, the throttle 108 is coupled to the steering input 102. The throttle may include a lever, button, paddle, switch, and/or grip that the user actuates with his or her hand. In some embodiments, the throttle 108 includes a button, a pedal, and/or a switch that the user actuates with his or her foot or other means. In response to a user input, the throttle 108 generates a throttle input (e.g., a throttle command) that is used to control the motor 106 and thereby a speed of the vehicle 100. The throttle 108 may be configured to cause the motor 106 to drive the vehicle 100 based on the throttle input.

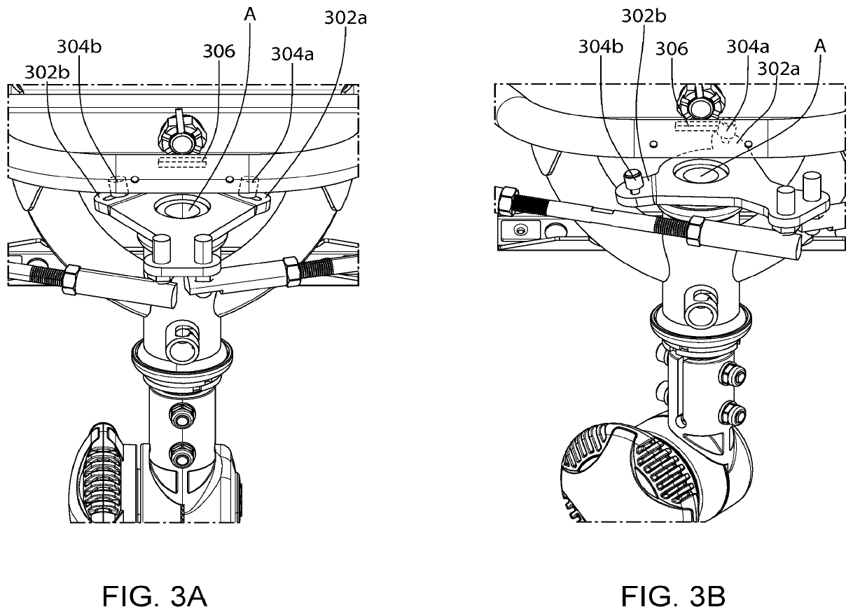

In some embodiments, the vehicle 100 includes a steering sensor 109 configured to monitor user control (e.g., steering and/or throttle), and/or detect a steering input 102 of the vehicle 100. In some embodiments, the steering sensor 109 includes at least one of: a steering position sensor configured to detect a steering position of the steering input 102 and a throttle input sensor configured to detect an amount of throttle 108 activated by a user. In some embodiments, the steering sensor includes contact sensors (e.g., sliding electrical contacts, spring loaded contacts, resistive potentiometer, electromechanical brushed coupling, mechanical switch cam coupling) or contact-less sensors (e.g., magnetic, inductive, ultrasonic, infrared (IR), laser, optical or capacitive sensors). A further example of steering position and steering rotation sensors are described in more detail below in reference to FIGS. 3A, 3B.

In some embodiments, the vehicle 100 includes at least one controller 110. In some embodiments, the at least one controller 110 may include one or more computers having at least one processor and memory. In some embodiments, the memory may store programs a processor executes to control and run the various systems and methods disclosed herein. In some embodiments, the at least one controller 110 may include at least one electrical circuit configured to execute the various systems and methods disclosed herein. The controller 110 may be coupled to the steering sensor 109 to monitor user control (e.g., steering and/or throttle) of the vehicle 100. The controller 110 may be configured to receive a steering indicator (e.g., steering indicator signal) from the steering sensor. In response to receiving the steering indicator (e.g., data such as steering position and/or throttle input), the controller 110 may be configured to process the one or more steering indicators and determine whether the steering indicator meets certain driving or turning criteria (described in more detail below). In response to a determination that the vehicle characteristics meet certain driving or turning criteria, the controller 110 may be coupled to the motor 106 and may be configured to cause the motor 106 to rotate in forward or reverse directions (or opposite directions) at one or more speeds to minimize plowing or oversteering.

FIGS. 3A and 3B illustrate an exemplary bottom perspective view of a front portion of the vehicle 100 and illustrates an exemplary steering position sensor system in accordance with at least one embodiment of the invention.

As illustrated in this example, a control system of the vehicle 100 is configured to track the steering position of the steering input 102 using a contactless sensor configuration. As shown, left and right extension arms 302a, 302b radially extend, relative to steering axis A, from a bottom of the steering input 102. In one embodiment, the left and right extension arms 302a, 302b include a left and right target 304a, 304b, respectively, attached proximate to an end of the left and right extension arms 302a, 302b. Left and right target 304a, 304b may include magnets. A sensor 306, such as Hall Effect sensor, may be attached to a frame of the vehicle 100 and coupled to the controller 110 (not shown in FIG. 3 but previously shown in FIGS. 1A-1C). The sensor 306 may be attached to an axle beam that is pivotably rotatable relative to the frame of the vehicle 100. In some embodiments, the sensor 306 is located along a steering axis A of the steering input 102 with the sensor 306 indicating the steering position of the steering input 102. As a user rotates the steering input 102, the steering input 102 causes the left and right extension arms 302a, 302b, and as a result, the targets 304a, 304b, to revolve around the steering axis A of the steering input 102. As the left and right extension arms 302a, 302b revolve, the targets 304a, 304b move relative to the sensor 306. When one of the targets 304a or 304b are proximate to the sensor 306, the sensor 306 detects a magnetic field produced by the target 304a or 304b, generates an output signal indicative of the detected magnetic field and transmits the output signal to the controller 110. The controller 110 then determines the position of the steering input 102. In some embodiments, the sensor 306 corresponds to a steering position of the steering input 102. For example, in FIG. 3B, sensor 306 corresponds to a left major-turn steering position.

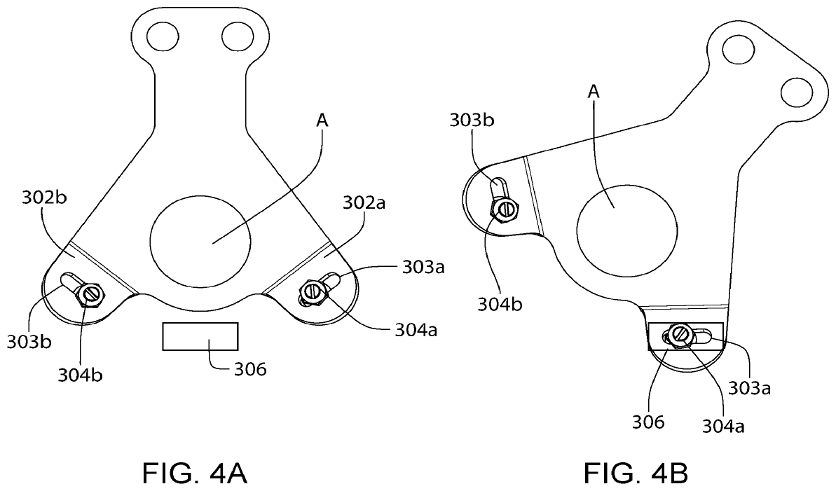

FIGS. 4A and 4B are a bottom perspective view of a front portion of the vehicle 100 showing the exemplary steering position sensor system in FIG. 3. The left and right extension arms 302a, 302b may include right and left slots 303a, 303b extending therethrough, respectively. Right and left slots 303a, 303b may be generally radially oriented relative to the steering axis A. Slots 303a, 303b may have a generally elongate oval shape with a length of about 13 mm to about 4 mm. In some embodiment the length of slot 303 is 12.5 mm. In some embodiment the length of slot 303 is 4 mm. In some embodiments, Slots 303a, 303b may have a length of 4 mm, 5 mm, 6 mm, 7 mm, 8 mm, 9 mm, 10 mm, 11 mm, 12 mm or 13 mm. Slots 303a, 303b may be sized to receive targets 304a, 304b, respectively. Slots 303a, 303b may have a width less than the diameter of targets 304a, 304b to prevent targets 304a, 304b from passing therethrough. Targets 304a, 304b may be moved relative to slots 303a, 303b to set or configure the distance between each target and the sensor as the steering input 102 is rotated by the user. In some embodiments, slots 303a, 303b may extend partially through the left and right extension arms 302a, 302b. In this example, slots 303a, 303b may be threaded and targets 304a, 304b may be screwed into slots 303a, 303b, respectively. In one embodiment, there may be more than one slot on the extension arms 302a, 302b. In FIG. 4B, the right target 304a is positioned over sensor 306 as a result of the steering input 102 being rotated by the user.

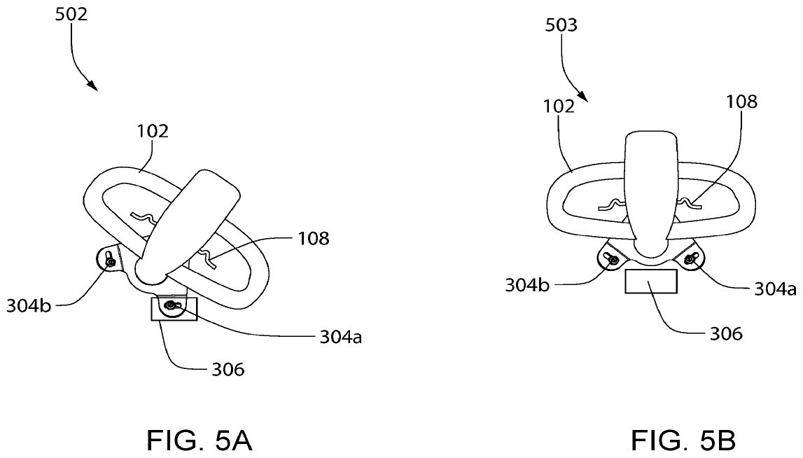

FIGS. 5A and 5B illustrate schematic representations 502, 503 of the exemplary steering position sensor system shown in FIGS. 3, 4 relative to steering input 102. FIGS. 5A and 5B represent a top view. In FIGS. 5A and 5B, the steering position sensor system includes the steering input 102. Throttle 108 is coupled to the steering input 102. The targets 304a, 304b may be coupled to the steering input 102. Sensor 306 is shown along the path of movement of the targets 304a, 304b. In this example, the sensor 306 is a Hall Effect sensor, but other sensors may be used, including capacitive and inductive sensors. In FIG. 5A, sensor 306, positioned closest to the target 304a, is represented as a solid square. In FIG. 5A, schematic representation 502 illustrates a steering input 102 in a right major-turn steering position because the target 304a is positioned in detectable range of sensor 306, which is representative of a right major-turn steering position, as discussed above. In FIG. 5B, schematic representation 503 illustrates a steering input 102 in a minor-turn steering position because the targets 304a, 304b are both positioned in a non-detectable range of from sensor 306, which is representative of a minor-turn steering position. The minor-turn steering position may refer to any position at which the sensor 306 is not activated by a target. The minor-turn steering position may be when the vehicle 100 is traveling in a straight direction. The major-turn steering position may refer to any position as which the sensor 306 is activated by a target. Sensor 306 is represented as an outlined square. Also, while not shown, the steering input 102 may be positioned such that left target 304b is positioned proximate to sensor 306 to represent the steering input 102 in a left major-turn steering position. In some embodiments, both targets are detectable by sensor 306 in major-turn mode and minor-turn mode in which case the modes are distinguished by the strength of the target signal detected by sensor 306.

The sensor 306 may activate when the steering input 102 is turned approximately 35°. In some embodiments, the sensor 306 may activate when the steering input 102 is turned approximately 30°. In some embodiments, the sensor 306 may activate when the steering input 102 is turned approximately 31°. In some embodiments, the sensor 306 may activate when the steering input 102 is turned approximately 32°. In some embodiments, the sensor 306 may activate when the steering input 102 is turned approximately 33°. In some embodiments, the sensor 306 may activate when the steering input 102 is turned approximately 34°. In some embodiments, the sensor 306 may activate when the steering input 102 is turned more than 30°. In some embodiments, the sensor 306 may activate when the steering input 102 is turned more than 25°. In some embodiments, the sensor 306 may activate when the steering input 102 is turned more than 35°. Major-turn mode may be entered when the steering input 102 is turned approximately 35°. In some embodiments, major-turn mode may be entered when the steering input 102 is turned approximately 30°. In some embodiments, major-turn mode may be entered when the steering input 102 is turned approximately 31°. In some embodiments, major-turn mode may be entered when the steering input 102 is turned 32°. major-turn mode may be entered when the steering input 102 is turned approximately 33°. In some embodiments, major-turn mode may be entered when the steering input 102 is turned approximately 34°. In some embodiments, major-turn mode may be entered when the steering input 102 is turned more than 30°. In some embodiments, major-turn mode may be entered when the steering input 102 is turned more than 25°. In some embodiments, major-turn mode may be entered when the steering input 102 is turned more than 35°.

In some embodiments, improved mobility and stability can be achieved by driving the right and left drive wheels 104a, 104b at different speeds during different steering operating modes. Exemplary steering operating modes are described as follows. In other embodiments, a trans-axle may drive the right and left drive wheels 104a, 104b at the same commanded speed.

As an example of a steering operating mode, the user may direct the vehicle 100 to perform a major-turn where the vehicle 100 rotates about a pivot point. In one embodiment, the pivot point is proximate to the inside drive wheel (see for example vertical axis B1 in FIG. 2). In some embodiments, the pivot point is on or near the rear wheel axis RA. In one embodiment, the mobility vehicle turns at its tightest turning radius where the pivot point of the turn is near or proximate the rear wheel track width. In some embodiments, a front wheel track width and a rear wheel track width may be equal. In some embodiments, the front wheel track width between the right and left directional control wheels 103a, 103b may be approximately 16.8 inches. In some embodiments, the rear wheel track width between right and left drive wheels 104a, 104b may be approximately 16.8 inches. In some embodiments, the front wheel track width and the rear wheel track width may be different. Although schematically illustrated as pivoting about a single point, in some embodiments, the pivot point is not precisely circular. In one embodiment, the axis of rotation B1 is aligned with the inside drive wheel during a major-turn when the inside drive wheel is turned to a maximum rotation. These configurations allow the vehicle 100 to navigate tight hallways or corridors. While some of the embodiments disclosed herein have a fixed pivot point, the present invention is not limited to a vehicle having a fixed axis of rotation in major-turn mode.

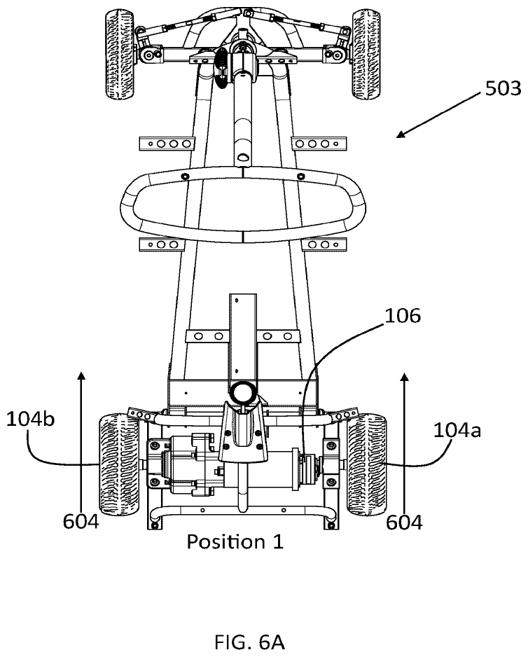

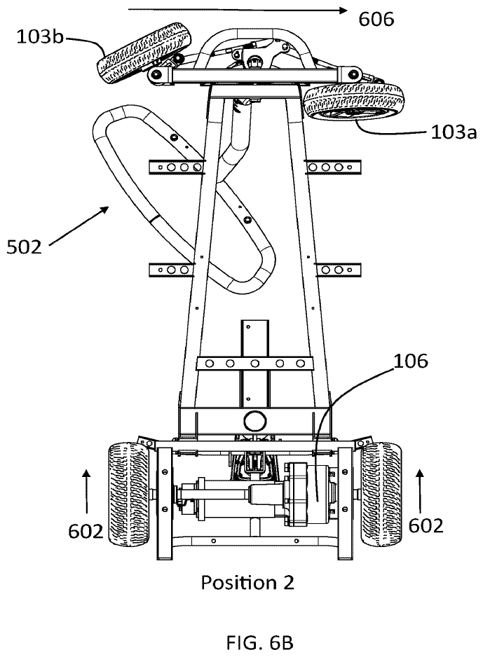

FIGS. 6A, 6B are schematic representations of vehicle 100 illustrating exemplary operation of minor-turn (here substantially a straight direction) and major-turn functionality (shown here is substantially max-turn mode) according to some embodiments of the invention. For example, in FIG. 6A, the steering input 102 is in a minor-turn position, as illustrated by schematic representation 503 (and as explained in detail in FIG. 5B). In some embodiments, in accordance with a determination by the controller 110 that the steering position is in a minor-turn position, controller 110 determines that minor-turn criteria is met. In response to determining that minor-turn criteria is met, in some embodiments, the controller 110 causes the vehicle 100 to operate in minor-turn mode by providing a first drive signal to the motor 106 to cause the motor 106 to drive the right and left drive wheels 104a, 104b in a forward direction at a first speed. In some embodiments, the first speed is equivalent to a commanded speed. In some embodiments, the first drive signal provided to the motor 106 causes the motor 106 to apply torque to the right and left drive wheels 104a, 104b in a forward direction (represented by the arrows 604).

In FIG. 6B, the steering input 102 is in a right major-turn position, as illustrated by schematic representation 502 (and as illustrated in FIG. 5A). The steering input 102 may be rotated such that the sensor 306 is activated, but is rotated less than to the maximum turn configuration. In some embodiments, an inside wheel is the wheel closest to a point that the vehicle turns about during the turn and the outside wheel is the wheel farthest from the point that the vehicle turns about during the turn. For example, in FIG. 6B, the right directional control wheel 103a is the inside wheel and the left directional control wheel 103b is the outside wheel. In some embodiments, in accordance with a determination by the controller 110 that the steering position is in a right major-turn position, controller 110 determines that major-turn entering criteria is met.

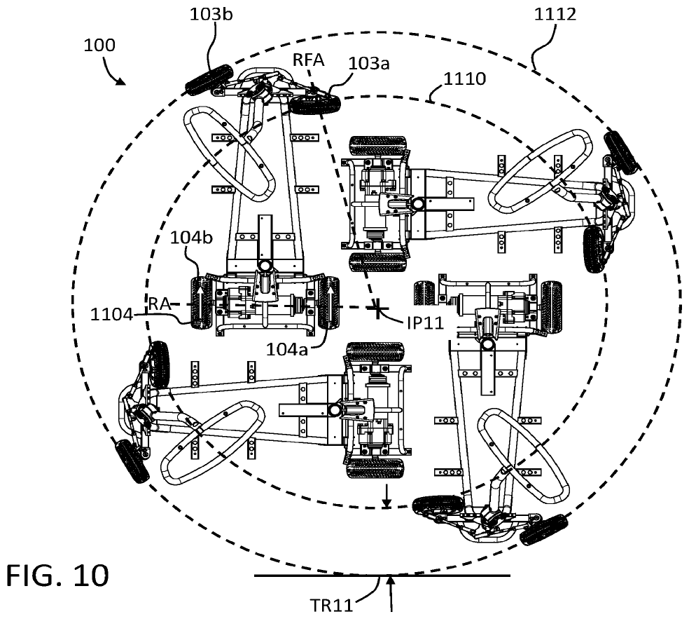

In some embodiments, in response to determining that major-turn entering criteria is met, in some embodiments, the controller 110 causes the vehicle 100 to operate in major-turn mode by providing a second drive signal to the motor 106 to cause the motor 106 to drive the right and left drive wheels 104a, 104b in a forward direction at a second speed. In some embodiments, the second drive signal provided to the motor 106 causes the motor 106 to apply torque to the right and left drive wheels 104a, 104b in a forward direction (represented by the arrow 602). In some embodiments, while the vehicle 100 is operating in major-turn mode, the first drive signal has a higher power (e.g., voltage, current) level than the second drive signal. This may allow the vehicle 100 to make a tighter, slower, and/or more stable turn than it would make if the vehicle did not enter major-turn mode. In some cases, this would prevent or limit plowing or understeering. In some cases, when vehicle 100 is max turn mode, vehicle 100 may rotate about an axis IP11 as illustrated in FIG. 10.

In some embodiments, the relationship between the second speed and first speed is variable. For example, if the vehicle is operating at a low enough first speed (e.g., a minimum forward travel speed) at a time an operator turns a steering input into a point that the major-turn mode is achieved, vehicle 100 may be configured to travel at a second speed that is equivalent to the first speed. In other instances when the first speed is sufficiently high when vehicle 100 enters the major-turn mode, second speed may be lower than the first speed. In some embodiments, the second speed may be the greater of: i) a fixed percent reduction of the first speed; and ii) the minimum forward speed. In some embodiments, the fixed percent reduction is one of about 75%, 70%, 65%, 60%, 55%, 50%, 45%, 40%, 35% or 30%. By way of illustration, consider the following examples of an exemplary vehicle 100 with a fixed percent reduction is selected as 50% in a vehicle with maximum speed of 6 mph and minimum forward speed of 1.5 mph. If the exemplary vehicle is operated at the maximum speed (6 mph in this example) at the moment the vehicle is operated to achieve the major-turn mode, the second speed would be 3 mph (50% of the commanded speed and greater than the minimum speed of 1.5 mph. Alternative, if vehicle 100 was operated at 2 mph when it is operated to enter the major-turn mode, second spend would be 1.5 mph since 50% of commanded speed would be less than the minimum forward speed. Thus, in response to determining that major-turn entering criteria is met, controller 110 causes the right and left drive wheels 104a, 104b to drive at the second speed, In some embodiments, the minimum forward speed of vehicle 100 is one of: 1 mph, 1.5 mph, 2 mph, 2.5 mph. In some embodiments, the maximum forward speed of the vehicle is 3.5 mph, 4, mph, 4.5 mph, 5 mph, 5.5 mph, 6 mph, 6.5 mph and 7 mph.

As discussed herein, the term “speed” may refer to actual wheel speed while no load is applied to the right and left drive wheels 104a, 104b. The term “speed” may also refer to an intended wheel speed commanded by the controller 110 via the one or more drive signals. In some embodiments, the commanded wheel speed may differ from the actual wheel speed of either the right or left drive wheels 104a, 104b due to external forces being exerted on each drive wheel 104a, 104b. For example, in some embodiments, while the absolute values of the drive signals to the motor 106, the reaction of the left and right drive wheels 104a, 104b may be different because the vehicle 100 uses steered right and left front wheels 103a, 103b, rather than caster wheels.

Arrow representations may be used to illustrate the speed and direction of the wheels. To illustrate a forward direction for a wheel, an arrow points towards the front of the vehicle 100, as illustrated by arrow 604 at right and left drive wheels 104a, 104b in FIG. 6A. To illustrate a reverse direction for a wheel, an arrow points towards the rear of the vehicle 100 (not shown). The length of the tail of the arrow corresponds to the speed of the corresponding wheel. By rotating the motor and wheels at certain speeds and in certain directions (e.g., as shown in FIGS. 6A and 6B and described above and below), the vehicle 100 has a reduced turning radius, thereby allowing the vehicle 100 to navigate tight hallways and corridors. This results in improved functionality and usability for the vehicle 100 because the vehicle 100 is now usable in more environments and situations than a vehicle with a larger turning radius.

In some embodiments, the controller 110 is configured to determine whether and when steering input 102 has transitioned from a minor-turn position to the major-turn position. In some embodiments, controller 110 is also configured to determine whether the throttle input exceeds a throttle input threshold to determine whether to cause the vehicle 100 to operate in major-turn mode or in standard driving mode (e.g., a commanded speed or first speed). If the controller 110 determines that the steering input 102 has transitioned from a minor-turn position to the major-turn position, and that the throttle input exceeds a throttle input threshold, the controller 110 causes the motor 106 to operate in major-turn mode. If the controller 110 determines that the steering input 102 has transitioned from a minor-turn position to the major-turn position, and the throttle input does not exceed a throttle input threshold, the controller 110 causes the motor 106 to operate in standard driving mode.

In some embodiments, the throttle input threshold is greater than 10%; greater than 20%; greater than 30%; greater than 40%; greater than 50%; greater than 60%; greater than 70%; greater than 80%; or greater than 90% of full throttle. In some embodiments, the throttle input threshold is from 5% to 50%; from 10% to 40%; from 15% to 35%; from 20% to 30%; or approximately 25% of full throttle.

In certain situations, entering major-turn mode can present undesirable conditions for the user of vehicle 100. While in a normal driving mode (e.g., a vehicle 100 driving in a forward direction), if the controller 110 simply causes the vehicle 100 to perform a major-turn in response to a quick turn of the steering input 102 by the user, the vehicle 100 may understeer or plow. To avoid these problem, the controller 110 is configured to cause the right and left drive wheels 104a, 104b to rotate at certain speeds based on the steering position of the steering input 102 and the throttle input of the throttle 108 that allow the vehicle 100 to safely enter a major-turn while being more responsive to the user's control inputs of the vehicle 100.

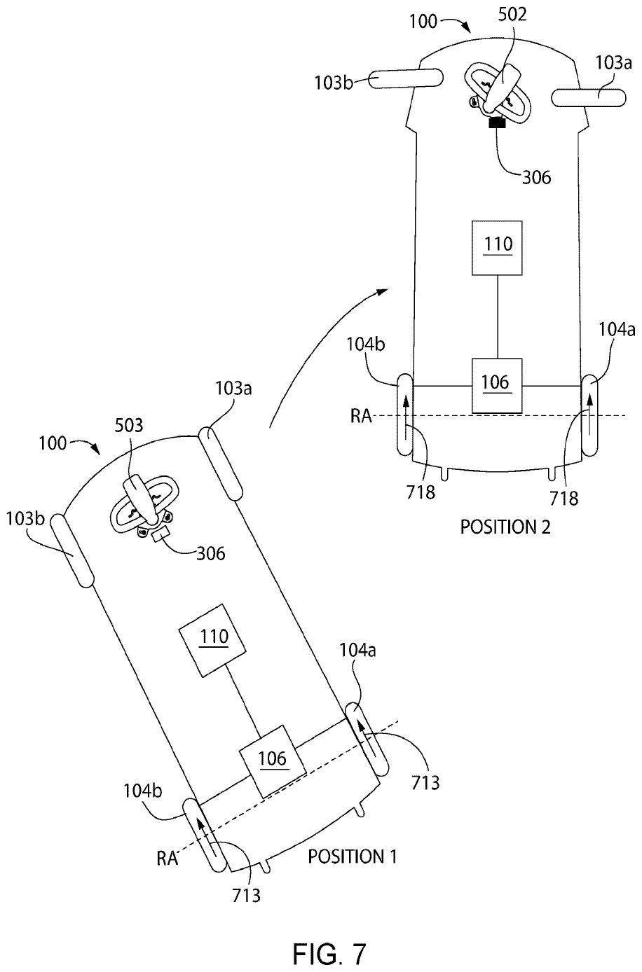

FIG. 7 is a schematic representation of vehicle 100 illustrating exemplary major-turn entering functionality where the steering input 102 has a transition to a major-turn position to enter into the major-turn mode of FIG. 6B, according to some embodiments of the invention. Position 2 illustrates a max-turn position which has turned past the major-turn threshold. In these embodiments, the controller 110 may operate the vehicle 100 in a major-turn mode when the controller 110 determines that major-turn mode entering criteria is met. In some embodiments, major-turn criterion is met when the steering position of the steering input 102 has transitioned from a minor-turn position to a major-turn position and the throttle input exceeds a throttle input threshold. In some cases, the existence of major-turn mode is independent of throttle input.

In FIG. 7, the vehicle 100 is shown in two positions: position 1 and position 2, with position 2 occurring after position 1. In position 1, the controller 110 determines that the steering input 102 is in a minor-turn position, as illustrated by schematic representation 503. In response to a determination that the steering input 102 is in a minor-turn position, the controller 110 operates the vehicle 100 in standard drive mode. Arrows 704 illustrate the speed and direction of the right and left drive wheels 104a, 104b at position 1. While in position 1, the steering input 102 has transitioned from the minor-turn position to a right max-turn position (as shown in position 2). In some embodiments, the controller 110 determines that major-turn criterion is met because the steering position of the steering input 102 has transitioned from a minor-turn position 503 to a major-turn position 502, and the throttle input exceeds a throttle input threshold. In response to a determination that major-turn criterion is met, as shown in position 2, the controller 110 causes the vehicle 100 to operate in a major-turn mode as shown in FIG. 6B. Specifically, in this example, the controller 110 provides the second drive signal that commands the motor 106 to drive the right and left drive wheels 104a, 104b in a forward direction at a reduced speed (e.g., 25% of full wheel speed). Arrows 702 illustrate the speed and direction of the right and left drive wheels 104a, 104b at position 2. By incorporating the above major-turn entering functionality, in some embodiments, the vehicle 100 can safely enter a major-turn without understeering or plowing despite a throttle input from a user that represents a user intent to drive the vehicle 100 at a fast speed that usually causes understeering.

Unless mitigated, exiting major-turn mode can present challenges to some users of the vehicle 100. For example, due to positioning of the directional control wheels while in major-turn mode, as described herein, it may be difficult for the user to exert enough force on the tiller to rotate the directional control wheels 103a, 103b from a major-turn position to a standard driving position. Also, if the controller 110 causes the right and left drive wheels 104a, 104b to rotate in a forward direction too quickly after detecting an input from the throttle 108, the vehicle 100 may understeer or plow in the direction of the major-turn. To avoid these problem, the controller 110 is configured to cause the motor 106 to drive the right and left drive wheels 104a, 104b at certain speeds to allow the vehicle 100 to safely exit a major-turn while being more responsive to the user's control inputs of the vehicle 100.

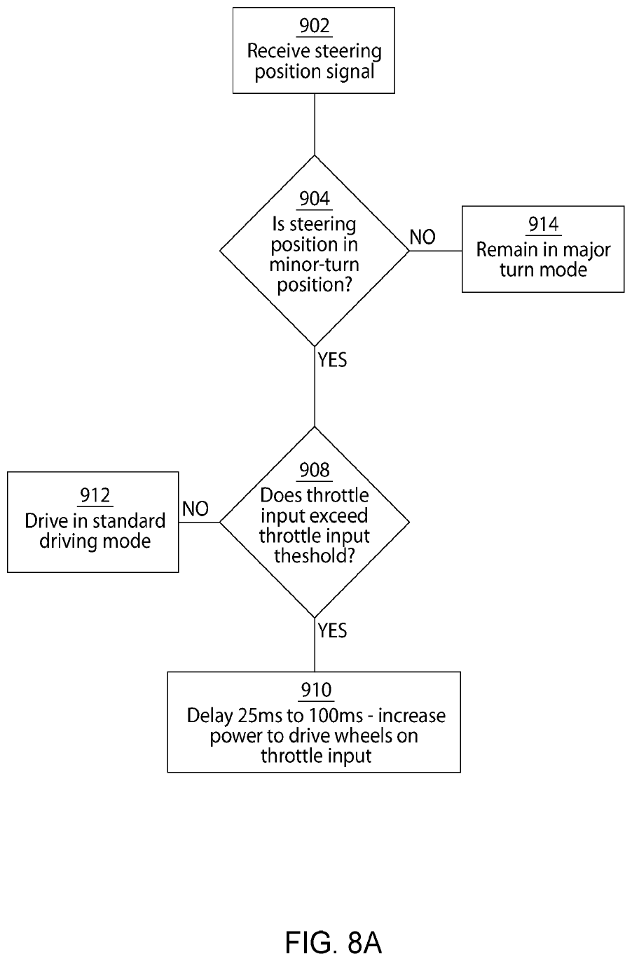

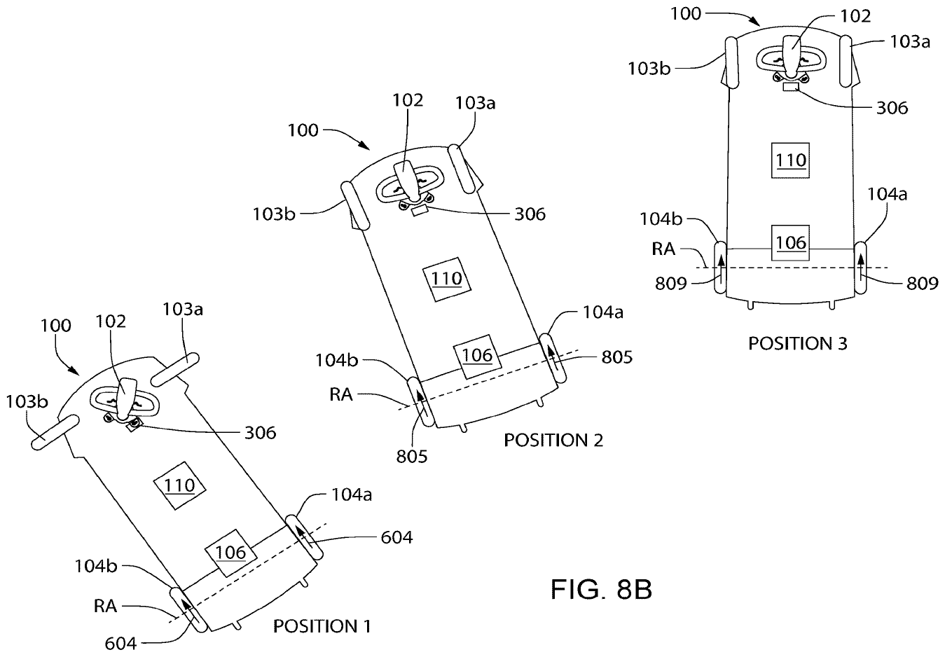

FIG. 8A is a flow chart illustrating functionality for determining whether a vehicle 100 meets major-turn exiting criteria, according to some embodiments of the invention. FIG. 8B is a schematic representations of vehicle 100 illustrating major-turn exiting functionality of FIG. 8A, according to some embodiments of the invention. For example, vehicle 100 may be accelerating out of a major-turn position into a minor-turn position.

In FIG. 8A, at step 802, while operating the vehicle 100 in major-turn mode, the controller 110 receives a steering indicator (e.g., steering position signal) from the steering sensor 109.

At step 804, the controller 110 determines whether the steering position of the steering input 102 is in a minor-turn position. If the controller 110 determines that the steering position of the steering input 102 is in a minor-turn position, the controller 110 proceeds to step 806. If the controller 110 determines that the steering position of the steering input 102 remains in a major-turn position, the controller 110 proceeds to step 812.

At step 806, the controller 110 determines whether the commanded speed indicated by the throttle 108 exceeds a predetermined throttle input threshold, for example, 50% of the maximum speed. If the controller 110 determines that the commanded speed indicated by the throttle 108 is below the predetermined throttle input threshold, the controller 110 proceeds to step 810 and allows for driving in standard driving mode. If the controller 110 determines that the commanded speed indicated by the throttle 108 is above the predetermined throttle input threshold, the controller 110 proceeds to step 808.

In some embodiments, the throttle input threshold is greater than 10%; greater than 20%; greater than 30%; greater than 40%; greater than 50%; greater than 60%; greater than 70%; greater than 80%; or greater than 90% of full throttle. In some embodiments, the throttle input threshold is from 5% to 50%; from 10% to 40%; from 15% to 35%; from 20% to 30%; or approximately 25% of full throttle.

At step 808, in response to a commanded speed indicated by the throttle 108, the controller 110 provides the third drive signal to the motor during a first time period. After the first time period, the controller 110 provides a fourth motor drive signal to the motor, the fourth motor drive signal configured to cause the motor to rotate the right and left drive wheels in the forward direction at a commanded speed indicated by the throttle 108. For example, in FIG. 8B, the controller 110 determines the steering input 102 transitioning from a major-turn position, as shown in position 1, to a minor-turn position, as shown in position 2. In response to a determination that the steering input 102 has transitioned from a major-turn position to a minor turn position, and the commanded speed indicated by the throttle 108 exceeds a predetermined throttle input threshold, the controller 110 causes the motor 106 to drive the right and left drive wheels 104a, 104b in a forward direction at a reduced speed (50% of that indicated by the throttle 108) for, for example, 500 ms, as shown at position 2. Arrows 805 illustrate the speed and direction of the right and left drive wheels 104a, 104b. After the time expires, the controller 110 causes the motor 106 to drive the right and left drive wheels 104a, 104b in a forward direction at a commanded speed indicated by the throttle 108 (shown as a full throttle), as shown in position 3. Arrows 807 illustrate the speed and direction of the right and left drive wheels 104a, 104b at a commanded speed indicated by the throttle 108.

In some embodiments, the first time period is from 20 to 1000 ms; from 50 to 900 ms; from 150 to 800 ms; from 300 to 700 ms; from 500 to 600 ms; or approximately 550 ms. In some embodiments; the first time period is less than 1000 ms; less than 900 ms; less than 800 ms; less than 700 ms; less than 600 ms; less than 500 ms; less than 400 ms; less than 300 ms; less than 200 ms; or less than 100 ms. At step 812, the controller 110 continues to operate the motor 106 in major-turn mode.

In some embodiments, the controller 110 determines whether to operate the vehicle 100 in major-turn mode if the steering input 102 is in a major-turn position and operate the vehicle 100 in standard drive mode if the steering input 102 is in a minor-turn position. For example, if the controller 110 receives a sensor position signal indicating that the steering input 102 is in a full left turn position or full right turn position (e.g., major-turn position), then the controller 110 causes the motor 106 to operate in major-turn mode. If the controller 110 receives a sensor position signal indicating that the steering input 102 is in a minor-turn position, then the controller 110 causes the motor 106 to operate in standard drive mode. In some embodiments, the sensor 306 may be configured to detect when the steering input 102 is in a major-turn position.

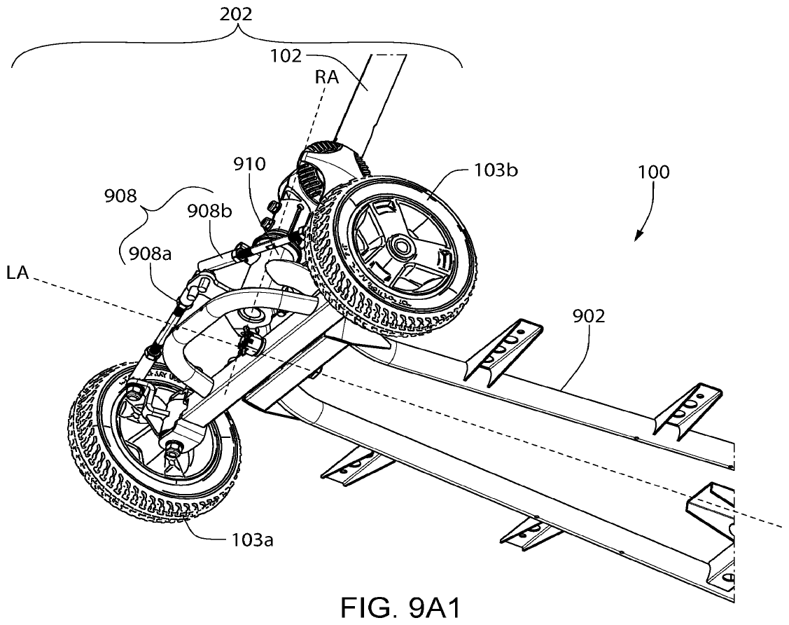

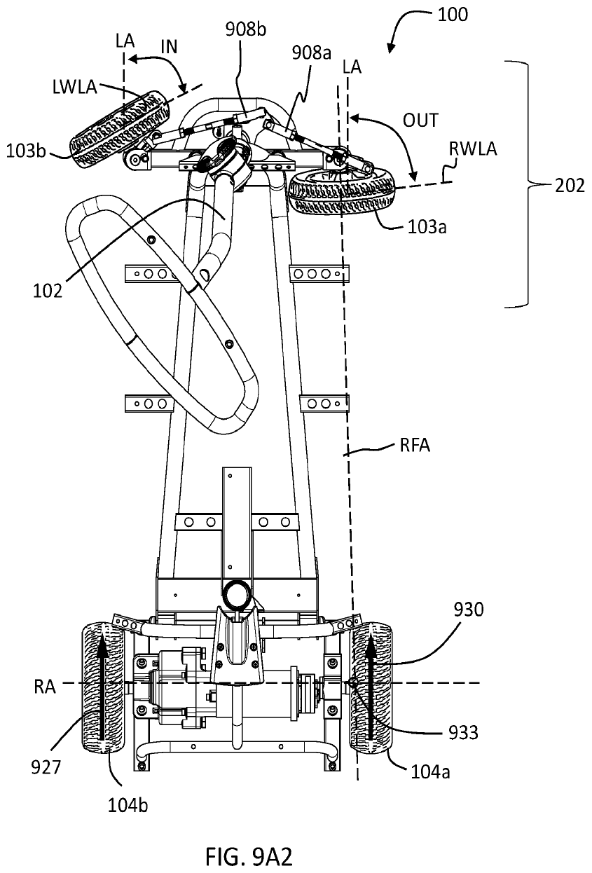

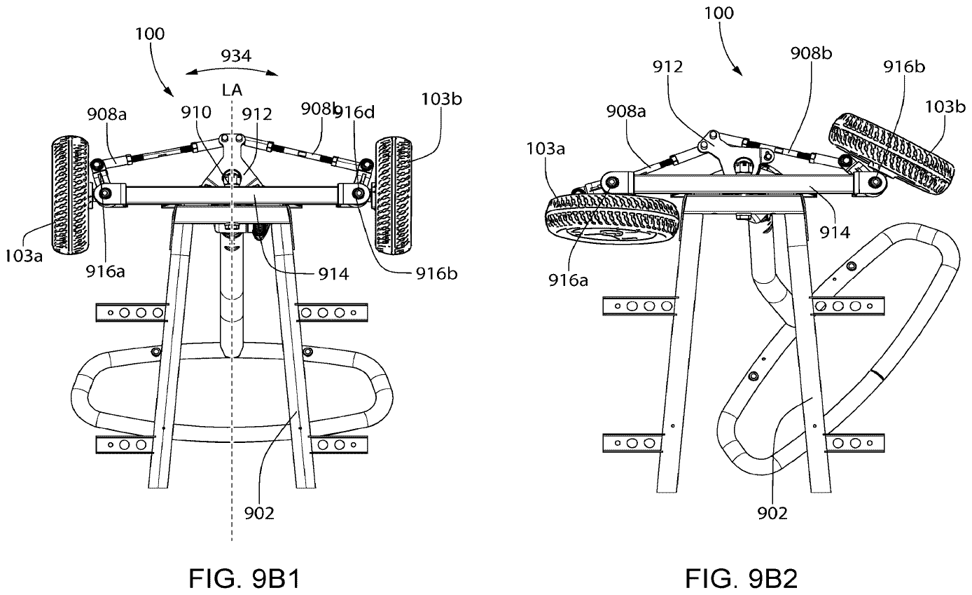

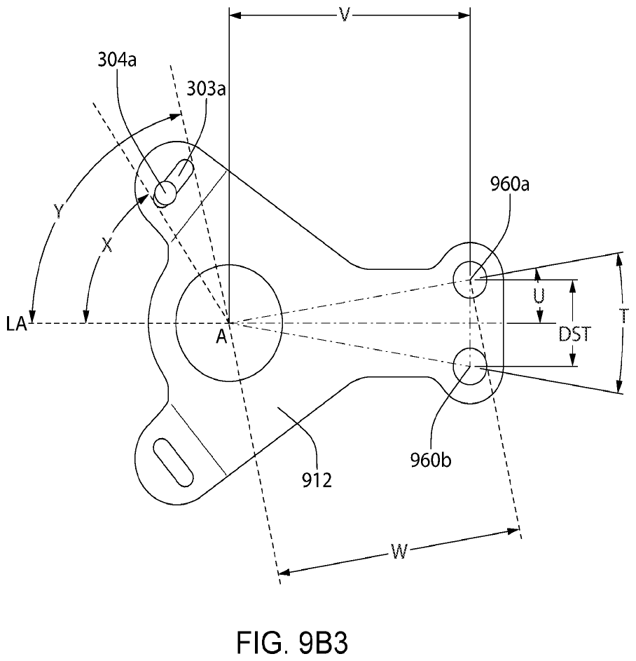

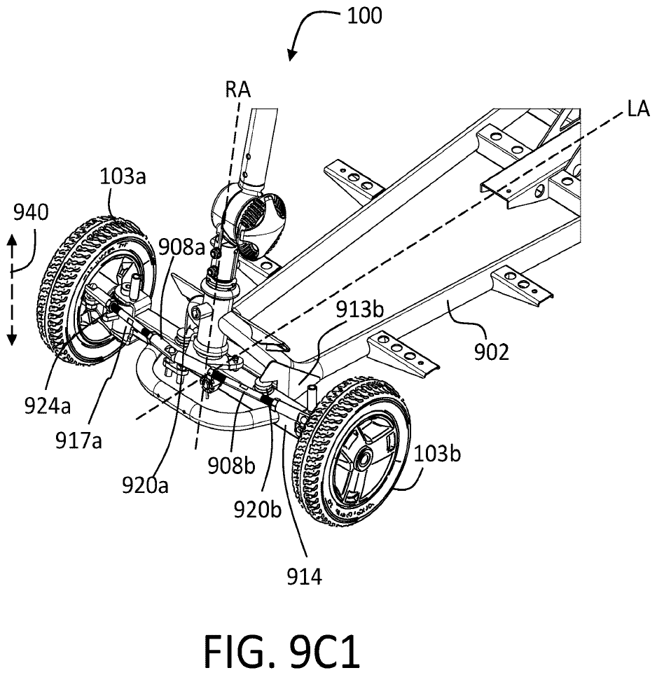

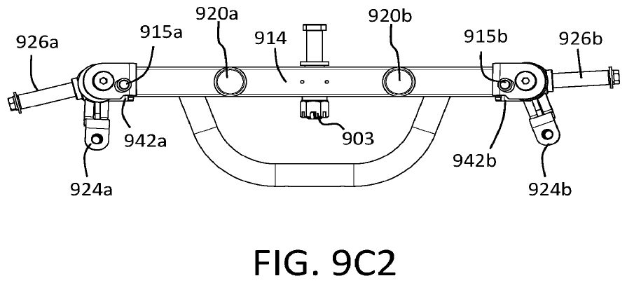

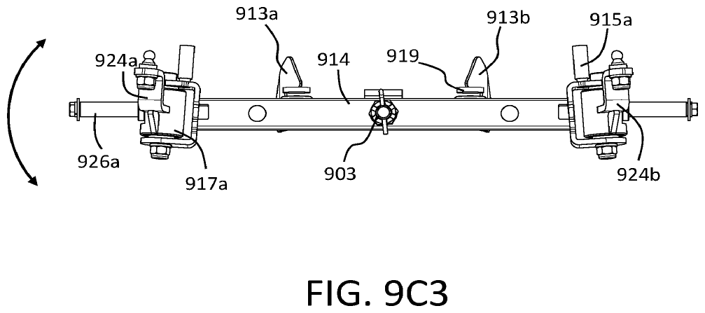

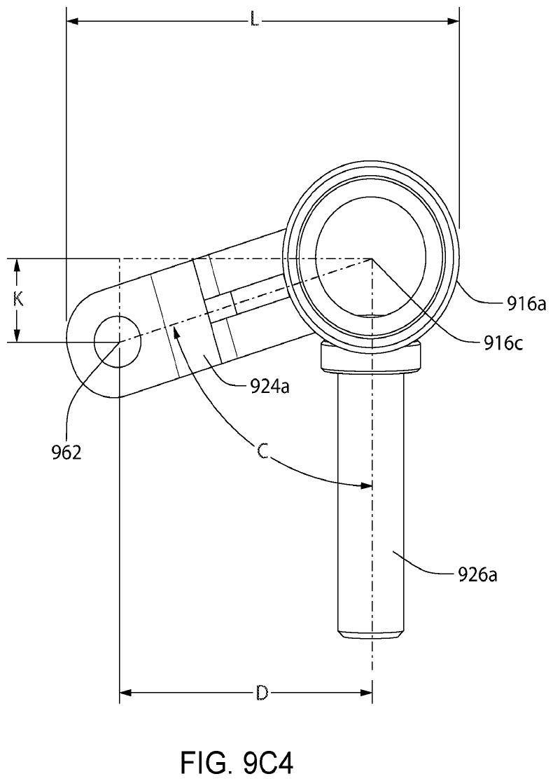

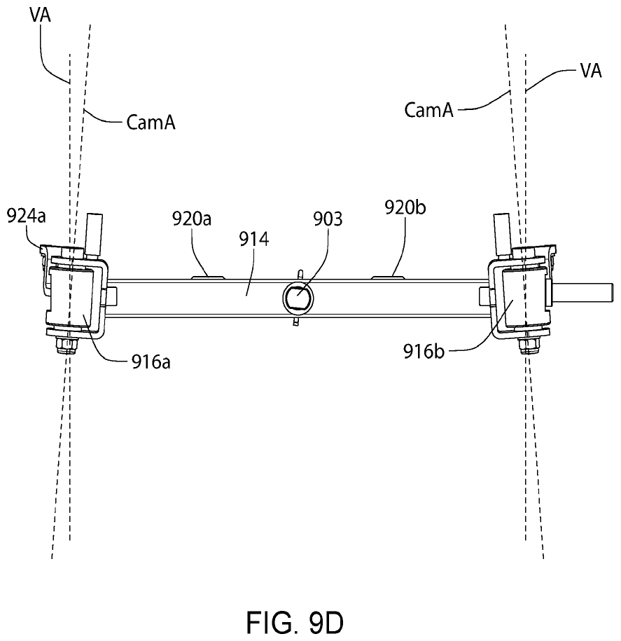

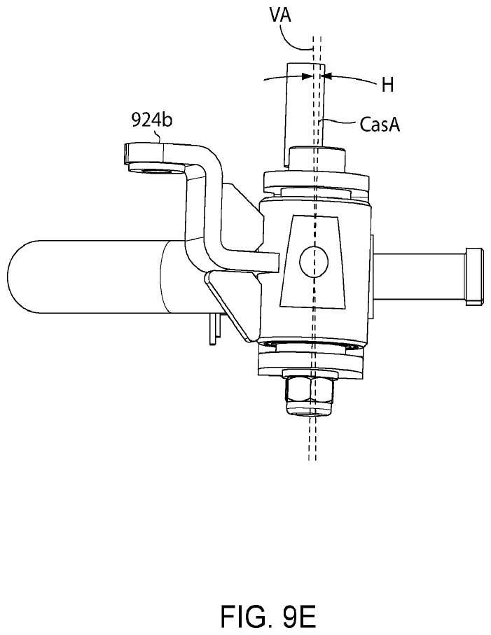

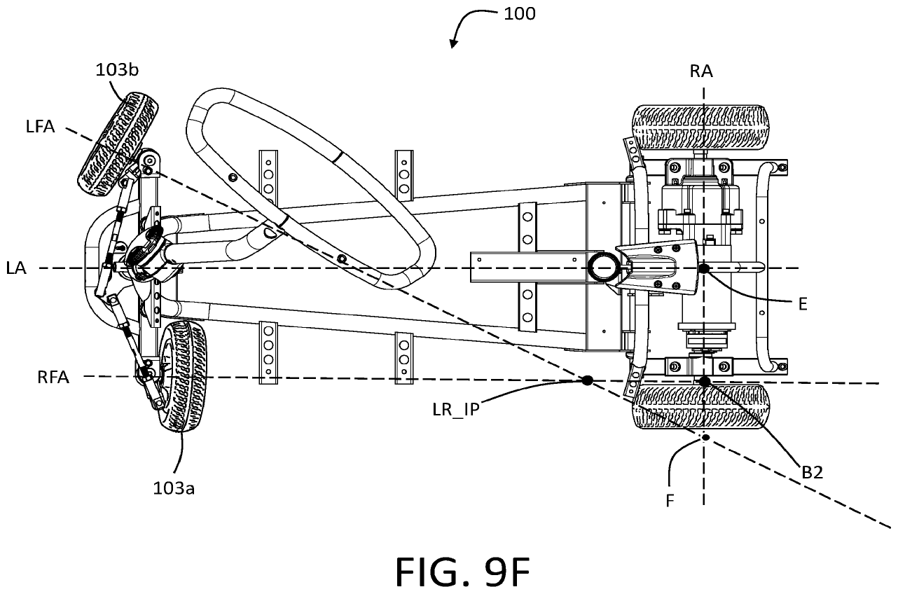

In some embodiments, vehicles such as mobility scooters having the functionality described above, are implemented with the steering assemblies and front-end configurations as described in the following embodiments. For example, embodiments of the steering assembly 202 are described below and shown in further detail in FIG. 9A1-9C3. FIG. 9A1 illustrates a bottom front perspective view of a portion of the vehicle 100 according to at least one embodiment of the invention. FIG. 9A2 illustrates a top view of a portion of the vehicle 100 according to at least one embodiment of the invention. FIG. 9B1, 9B2 illustrate bottom views of a portion of the vehicle 100 according to at least one embodiment of the invention. FIG. 9C1 illustrates a top front perspective view of a portion of the vehicle 100 according to at least one embodiment of the invention. FIG. 9C2, 9C3 illustrate a top and front views, respectively, of a steering assembly 202 of the vehicle 100, according to at least one embodiment of the invention.

Turning now to FIG. 9A1, the vehicle 100 may include a frame 902. The frame 902 may be disposed along a longitudinal axis LA. The vehicle 100 may include steering assembly 202. The steering assembly 202 may be coupled to the frame 902. The steering assembly 202 may have a left directional control wheel 103b and the right directional control wheel 103a positioned on either side of the longitudinal axis of the frame 902. The right and left directional control wheels 103a, 103b may also be referred to herein as right and left front wheels 103a, 103b. The right and left front wheels 103a, 103b may be coupled to the steering input 102 via a steering linkage 908 (also referred to herein as linkage member). In some embodiments, the steering linkage 908 includes a right tie rod 908a and a left tie rod 908b.

The steering linkage 908 may be configured to pivot in response to movement of the steering input 102. The steering linkage 908 may be pivotable about rotation axis RA. The steering linkage 908 may be configured and dimensioned such that each of the right front wheel 103a and the left front wheel 103b has a maximum inward turn angle. As used herein, inward turn angle refers to the direction of a wheel relative to the longitudinal axis such that a vector representing the forward direction of the wheel would cross the longitudinal axis. Also as used herein, an outward turn angle refers to the direction of a wheel relative to the longitudinal axis such that a vector representing the forward direction of wheel would diverge from the longitudinal axis. In a vehicle turn, a front wheel having an inward turn angle would be an outside front wheel and the front wheel having an outward turn angle would be an inside front wheel.

The maximum inward turn angle may be characterized by a limit to which either the left front wheel 103b or right front wheel 103a can turn inward relative to the longitudinal axis. For example, in FIG. 9A2, while the steering input 102 is positioned in a full-right turn (e.g., major-turn position), the left front wheel 103b (e.g., the outside front wheel) has a maximum inward turn angle IN of 63° represented in FIG. 9A2 as the angle between longitudinal axis LA and left wheel longitudinal axis LWLA.

In some embodiments, the maximum inward turn angle IN is approximately 61°, approximately 62°, approximately 64° or approximately 65°. In some embodiments, the maximum outward turn angle is greater than 61°, greater than 62°, greater than 63°, greater than 64°, or greater than 65°.

Each of the left front wheel 103b or right front wheel 103a may be configured to have a firm maximum inward turn angle and corresponding variable outward maximum turn angle. For example, a firm maximum inward turn angle may be caused by rigid members in the steering assembly engaging each other to limit their respective movement. In some embodiments, the maximum outward turn angle is governed by the corresponding front end linkage and can only be achieved when the outside wheel is turned to reach the maximum inward turn angle. In some embodiments, the steering assembly 202 is configured to position the inside wheel to the intermediate maximum outward turn angle when the outside wheel is turned to the maximum inward turn angle.

At the maximum inward turn angle, in some embodiments, the pivot point at which the tie rod is linked to the steering arm is positioned rearward of a line passing through the two kingpin axes. In some embodiments, each of left front wheel 103b and right front wheel 103a have a maximum inward turn angle and a maximum outward turn angle. The maximum outward turn angle may be characterized by a limit to which the front of either the left front wheel 103b or right front wheel 103a can turn away from the longitudinal axis (in some embodiments, while the vehicle 100 is at rest). In some embodiments, when the right and left front wheel 103a, 103b (e.g., inner wheel) is turned to a respective right or left maximum inward turn angle, the other of the right and left front wheel 103a, 103b (e.g., outer wheel) is turned to the maximum outward angle. For example, in FIG. 9A2, and in some embodiments, the maximum outward turn angle OUT is approximately 86° as represented in FIG. 9A2 as the angle between longitudinal axis LA and right wheel longitudinal axis RWLA. In FIG. 9A2, while the steering input 102 is positioned in a full-right turn, and the right and left drive wheels 104a, 104b are driven in a forward direction, indicated by the representative arrows 930 and 927 on the right and left drive wheels 104a, 104b, the right front wheel 103a has a maximum outward turn angle of 86°. While turning, the vehicle 100 pivots about intersection point 933 of the right front wheel axis RFA and the rear wheel axis RA. The maximum outward turn angle may be controlled by a stop 915 fixed proximate the kingpin as described in more detail below.

In some embodiments, the maximum outward turn angle is approximately 84°, approximately 85°, approximately 86°, approximately 87°, or approximately 88°. In some embodiments, the maximum outward turn angle is greater than 84°, greater than 85°, greater than 86°, greater than 87°, or greater than 88°.

In some embodiments, the controller 110 is configured to power each of the first drive wheel and the second drive wheel (e.g., right and left drive wheels 104a, 104b) at power levels of approximately the same absolute value and in the same direction when one of the left front wheel or right front wheel (e.g., right or left front wheel 103a, 103b) is in the maximum outward angle. In some embodiments, the controller 110 may be configured to direct a trans-axle to power both the right and left drive wheels 104a, 104b with the same commanded speed.

In some embodiments, the first drive wheel (e.g., right drive wheel 104a) operates at a different revolutions per minute (or angular velocity) than the second drive wheel (e.g., left drive wheel 104b) when the power levels are of approximately the same absolute value. This can arise because of the relative configuration of the steering assembly 202 at the time the wheels are being powered and the geometry of the turn arc.

The steering assembly 202 may include a steering stem 910 and/or a stem tab 912 as illustrated in FIG. 9B1 and 9B2. The stem tab 912 may be coupled to the steering stem 910. The stem tab 912 may rotate about the steering stem 910 in response to movement of the steering input 102, as illustrated by representative arrow 934, for example. Steering assembly 202 may include a linkage member 908 that may be coupled to the stem tab 912. The linkage member 908 may be configured to pivot in response to movement of the steering input 102, via the steering stem 910 and stem tab 912. The linkage member 908 may include one or more tie rods, such as right tie rod 908a and left tie rod 908b shown in FIG. 9B1, 9B2. The right and left tie rods 908a, 908b may be pivotably coupled to the stem tab 912. The right and left tie rods 908a, 908b may be configured to pivot, via the steering stem 910 and stem tab 912, in response to movement of the steering input 102 to cause the right and left front wheels 103a, 103b to orient relative to the steering position of the steering input 102. In one embodiment, as shown in FIG. 9B3, stem tab 912 comprises two tie rod connection points 960a, 960b separated by a distance DST. Stem tab 912 may pivot about a steering stem 910 at a steering stem pivot point A. As described in more detail above, stem tab 912 comprises right and left slots 303a, 303b extending therethrough. In some embodiments, the angle X between a line of the stem pivot point A and a first end of right slot 303a and the longitudinal axis LA may be 56°. In some embodiments, the angle Y between a line of the stem pivot point A and a second end of right slot 303a and the longitudinal axis LA may be 75°. As such, target 304a may be adjusted within slot 303a such that target 304a may be fixed at a point between 56° and 75° relative to the longitudinal axis LA. In some embodiments, the target 304a may be adjusted within slot 303a such that target 304a may be fixed at a point between 50° and 80° relative to the longitudinal axis LA. Left target 304b may be adjusted within slot 303b in the same manner as described above.

In some embodiments, a distance V (see, FIG. 9B3) between the stem pivot point A and the tie rod connection points 960a, 960b along the longitudinal axis LAis approximately 2.24 inches or 56.924 mm (See, FIG. 9B3). In some embodiments, the distance V is approximately 2.0 inches, 2.1 inches, 2.2 inches, 2.3 inches, 2.4 inches or 2.5 inches. In some embodiments, the distance V is greater than 2.0 inches, 2.1 inches, 2.2 inches, 2.3 inches, 2.4 inches or 2.5 inches.

In some embodiments, a distance W between the stem pivot point A and the first tie rod connection point 960a is approximately 2.27 inches or 57.71 mm (See, FIG. 9B3). In some embodiments, the distance W is approximately 2.0 inches, 2.1 inches, 2.2 inches, 2.3 inches, 2.4 inches or 2.5 inches. In some embodiments, the distance W is greater than 2.0 inches, 2.1 inches, 2.2 inches, 2.3 inches, 2.4 inches or 2.5 inches. In some embodiments, the distance between the stem pivot point A and the second tire rod connection point 960b is the same as that of the first tie rod connection point 960a.

In one embodiment, the angle T between a line from the stem pivot point A and the first tie rod connection point 960a and a line from the stem pivot point A to the second tie rod connection point 960b is approximately 19°. In some embodiments, the angle T is approximately 18° or 20°. In one embodiment, the angle U between a line of the stem pivot point A and the first tie rod connection point 960a and the longitudinal axis LA is approximately 9.5°. In some embodiments, the angle U is approximately 9° or 10°.

As illustrated in FIG. 9B1, 9B2, the steering assembly 202 may include an axle beam 914. The axle beam 914 may be pivotably mounted to the frame 902. The steering assembly 202 may have two axes of rotation relative to the frame 902, the rotation axis RA and the longitudinal axis LA as shown in FIG. 9C1. Both axes may be proximately normal to each other. The steering assembly 202 may be coupled to the frame only at the stem pivot point A and axle pivot point 903. The stem pivot point A may define the point at which the steering assembly 202 pivots about the rotation axis RA and the axle pivot point 903 may define the point at which the axle beam 914 pivots about the longitudinal axis LA. The rotation axis RA and the longitudinal axis LA may be generally perpendicular as shown in FIG. 9C1. The axle beam 914 may be coupled to the frame 902 only at axle pivot point 903. The axle beam 914 may be configured to pivot relative to the longitudinal axis LA such that right and left front wheels 103a, 103b remain in contact with the ground surface during use of the vehicle 100. The axle beam 914 may be prevented from rotating relative to the frame 902 when right and left stops 920a, 920b contact the frame 902. In some embodiments, the axle beam 914 may be prevented from rotating relative to the frame 902 when right and left stops 920a, 920b contact a right and left gusset 913a, 913b of the frame 902. Right and left gussets 913a, 913b may extend from the frame 902 such that a receiver 919 may be proximate right and left stops 920a, 920b and contact the right and left stops 920a, 920b, respectively, when the axle beam 914 rotates relative to the frame 902. In some embodiments, the axle beam 914 does not rotate relative to the frame 902. In some embodiments, the axle beam 914 is fixed relative to the frame 902.

The axle beam 914 may pivot approximately 3.8° relative to the frame 902. In some embodiments, the axle beam 914 may pivot approximately 4° relative to the frame 902. In some embodiments, the axle beam 914 may pivot approximately 3.9° relative to the frame 902. In some embodiments, the axle beam 914 may pivot approximately 3.7° relative to the frame 902. In some embodiments, the axle beam 914 may pivot approximately 3.6° relative to the frame 902. In some embodiments, the axle beam 914 may pivot approximately 3.5° relative to the frame 902.

The axle beam 914 may be substantially perpendicular to the longitudinal axis LA of the vehicle 100. Axle beam 914 may be substantially linear from kingpin 916a to kingpin 916b. In some embodiments, illustrated for example, in FIG. 9B2, left tie rod 908b is pivotably connected to left steering arm 924b at steering/rod pivot point. Left tie rod 908b is also pivotably connected to stem tab 912 at a tab/rod pivot point. In some embodiments, when left tie rod 908b is pivoted in a maximum inside turn pivot, tie rod 908b may be brought into close proximity (e.g., without touching) the axis of kingpin 916b. In some embodiments, steering assembly 202 may be configured to allow camover of left tie rod 908b such that it passes behind the axis of kingpin 916b. In some embodiments, a bump or stop (as described in more detail below) is provided to limit or prevent that cam-over. In some embodiments, a slight cam over effect is induced which may enhance the biasing force to keep the inside drive wheel at the outward major-turn position. In some embodiments, the bias caused by the cam over can be relieved by altering the motion of the drive wheels.

The steering assembly 202 may include right kingpin 916a and/or a left kingpin 916b coupled to the axle beam 914. The right kingpin 916a and/or a left kingpin 916b may be rotatable about a respective kingpin axis 916c, 916d. The right and left kingpins 916a, 916b may be configured to allow each of the respective right and left front wheels 103a, 103b to pivot along one the respective kingpin axes 916c, 916d. The right and left tie rod 908a, 908b may be pivotably coupled to a respective right and left kingpin 916a, 916b.

In some embodiments, such as in FIG. 9C1-9C3, the steering assembly 202 may include right steering arm 924a and/or a left steering arm 924b to couple the right and left kingpins 916a, 916b to the right and left tie rods 908a, 908b. The right and left steering arms 924a, 924b may couple to the respective right and left kingpins 916a, 916b via right and left kingpin sleeves 917a, 917b. Each of the right steering arm 924a and a left steering arm 924b may be rotatable about and projecting from the right and left kingpin axes 916c, 916d, respectively. In some embodiments, the right steering arm 924a and/or a left steering arm 924b is configured to project a distance that is configured to achieve the maximum outward turn angle without confronting the inside of the inside wheel. In this configuration, movement of the steering input 102 causes the right and left front wheels 103a, 103b to reorient accordingly.

As shown in FIG. 9C2 and 9C3, the steering assembly 202 may include a right stop 915a and a left stop 915b. Right stop 915a and left stop 915b are configured to prevent elements (e.g., tie rods) of steering assembly 202 from passing beyond right stop 915a and left stop 915b respectively, in some embodiments. By limiting movement of components of steering assembly 202, the respective right wheel and left wheel reach their respective maximum turn angle. In some embodiments, right stop 915a and a left stop 915b are positioned on axle beam 914. In some embodiments, as the right tie rod 908a and/or left tie rod 908b pivot, the right tie rod 908a or left tie rod 908b may engage the right stop 915a or left stop 915b, respectively, when one of the right or left front wheels 103a, 103b reaches the respective maximum outward turn angle. The right stop 915a and left stop right stop 915b may be configured to prevent the right front wheel 103a and the left front wheel 103b from turning beyond the respective maximum outward turn angle. FIG. 9B2 illustrates a vehicle 100 in a full left turn. The left tie rod 908b is pivoted and has engaged the left stop 915b such that the left front wheel 103b is at a maximum outward turn angle.

In some embodiments, such as in FIG. 9C2, 9C3, the steering assembly 202 includes a right wheel axle 926a and left wheel axle 926b coupled to the right and left kingpin 916a, 916b respectively. Each of the right and left wheel axles 926a, 926b being rotatable about and projecting from the right and left kingpin axis 916c, 916d respectively. The right front wheel 103a and left front wheel 103b may be rotatable about the respective right and left wheel axle 926a, 926b, respectively.

In some embodiments, each of the right steering arm 924a and left steering arm 924b is fixed relative to the right and left wheel axle 926a, 926b respectively at an angle of approximately 73°. For example, in FIG. 9C4, angle C between right steering arm 924a and right wheel axle 926a is shown as 73°. In some embodiments, angle C may be an angle of 68°, an angle of 69°, an angle of 70°, an angle of 71°, an angle of 72°, an angle of 74°, an angle of 75°, an angle of 76°, an angle of 77°or an angle of 78°. In some embodiments, each of the right and left steering arms 924a, 924b includes a tie rod connection point 962. For example, in FIG. 9C4, the right steering arm 924a includes a tie rod connection point 962. A distance D between a center of a tie rod connection point 962 and a kingpin axis 916c of kingpin 916a may be approximately 1.81 inches or 45.9 mm. In some embodiments, the distance D may be approximately 1.5 inches, 1.6 inches, 1.7 inches, 1.8 inches, 1.9 inches or 2 inches. A distance K between a center of a tie rod connection point 962 and a kingpin axis 916c of kingpin 916a may be approximately 0.55 inches or 14.03 mm. In some embodiments, the distance K may be approximately 0.3 inches, 0.4 inches, 0.5 inches, 0.6 inches, 0.7 inches or 0.8 inches. A distance L between an outer surface of kingpin 916a and an outer surface of steering arm 924c may be approximately 2.8 inches or 71.15 mm. In some embodiments, the distance L may be approximately 2.5 inches, 2.6 inches, 2.7 inches, 2.9 inches or 3.0 inches. Referring to FIG. 9B3 and 9C4, in some embodiments, a ratio between (i) a distance D between a center of a tie rod connection point 962 and a kingpin axis 916a and (ii) a distance V between a tie rod connection point 960 and a steering axis A is approximately 1:1.24. In some embodiments the ratio may be 1:1.1, 1:1.15, 1:1.2, 1:1.25, 1:1.3 or 1:1.35.

In some embodiments, the axle beam 914 may comprise one or more cutouts, such as right and left cutouts 942a, 942b shown in FIG. 9C2. When the right or left front wheel 103a, 103b is at a maximum inward turn angle, the respective right or left steering arm 924a, 924b is configured to register within the respective right and left cutout 942a, 942b.

FIGS. 9D, 9E are front and left side views, respectively of a portion of the steering assembly 202, according to at least one embodiment of the invention. In some embodiments, the steering assembly 202 includes an axle beam 914, a right steering arm 924a, a right kingpin 916a, a left steering arm 924b and a left kingpin 916b. The right steering arm 924a and the left steering arm 924b may be oriented relative to a plane defined by the longitudinal axis and the vertical axis of the vehicle 100 at a camber angle G of approximately 4° (see, e.g., FIG. 9D). As used herein, camber angle G may be the angle between the vertical axis of the vehicle and the vertical axis of the wheels when viewed from the front of the vehicle. In some embodiments, the right kingpin 916a, and left kingpin 916b may be oriented relative to a plane defined by the lateral axis and the vertical axis of the vehicle 100 at a caster angle H of approximately 5° (see, e.g., FIG. 9E). As used herein, caster angle H may be an angular displacement of the steering axis of the wheels from the vertical axis of a vehicle. FIG. 9D illustrates an axle beam 914 having a camber angle G of 4° as illustrated by vertical axis VA and camber axis CamA. FIG. 9E illustrates a left side view of left steering arm 924b having a caster angle H of 5° as illustrated by vertical axis VA and caster axis CasA.

FIG. 9F is a top view of the vehicle 100 in a major-turn mode configuration, according to at least one embodiment of the invention. In FIG. 9F, right and left drive wheels 104a, 104b rotate about a rear wheel axis RA. Right front wheel 103a rotates about a right front wheel axis RFA. Left front wheel 103b rotates about a left front wheel axis LFA. While the right front wheel 103a is at a maximum inner turn angle, as shown in FIG. 9F, projections of the right front wheel axis RFA and left front wheel axis LFA intersect at a vertical projection intersection point LR_IP that is forward of the rear wheel axis RA. In some embodiments, the left front wheel axis LFA and right front wheel axis RFA projections intersect at a point that is set off from a longitudinal axis LA on the right side of the frame 902 when the left front wheel is at the maximum outward turn angle. By configuring the right and left front wheels 103a, 103b such that the vertical projection intersection point LR_IP is proximate to the inner drive wheel, a tight turning radius about a pivot point can be achieved. For example, in some embodiments, the pivot point of the vehicle 100 is proximate the inside drive wheel (e.g., vertical axis B proximate right drive wheel 104 a in FIG. 9F). In some embodiments, while the vehicle 100 operates in major-turn mode, the turning radius is substantially controlled by the inside wheel. The steering assembly 202 may be configured to permit the outside wheel (e.g., left front wheel 103b) to slide and thereby not influence or only minimally influence turn radius of the vehicle 100.

In some embodiments, the distance between the vertical projection intersection point LR IP and the rear wheel axis RA is approximately 1.46 inches or 37 mm, when the one of the right and left front wheel 103a, 103b is rotated towards a maximum outward turn angle. In some embodiments, the distance between the vertical projection intersection point LR_IP and the rear wheel axis RA is approximately 1.2 inches, 1.3 inches, 1.4 inches, 1.5 inches, 1.6 inches or 1.7 inches. In some embodiments, a distance between vertical projection intersection point LR_IP and the longitudinal axis decreases as the one of the right and left front wheel 103a, 103b rotates towards a maximum outward turn angle. In some embodiments, the distance between the vertical projection intersection point LR_IP and the longitudinal axis LA is approximately 8.54 inches or 216.91 mm, when the one of the right and left front wheel 103a, 103b is rotated towards a maximum outward turn angle. In some embodiments, the distance between the vertical projection intersection point LR_IP and the longitudinal axis LA is approximately 7.0 inches, 7.5 inches, 8 inches, 8.5 inches, 9 inches, 9.5 inches or 10 inches. In some embodiments, the distance between vertical projection intersection point LR_IP and the rear wheel axis RA varies linearly as the one of the right and left front wheel 103a, 103b pivots towards a maximum outward turn angle. In some embodiments, the vertical projection intersection point LR_IP is at, near or proximate to the rear wheel axis RA.

Some embodiments of vehicle 100 includes a wheel base defined by the distance between rear wheel axis RA and a front kingpin axis (drawn through kingpins 916a and 916b). In some embodiments, the wheel base is under three feet. In some embodiments, the wheel based is between 30 inches and 36 inches. In some embodiments, the wheel base is approximately 30 inches. The turn radius to wheelbase ratio may be approximately 1:1.3. In some embodiments, the turn radius to wheelbase ratio may be approximately 1:1.25. In some embodiments, the turn radius to wheelbase ratio may be up to 1:1.25.

FIG. 10 is a schematic representation of the turning radius of vehicle 100 in a maximum turn configuration according to some embodiments of the invention.

FIG. 10 is a schematic representation of a turn radius of the vehicle 100 conducting a turn with the inner wheel at a maximum outward turn angle, and operating in major-turn mode according to some embodiments of the invention. In FIG. 10, the left front wheel 103b and the right front wheel 103a are in a right turn configuration, with the right front wheel 103a corresponding to the inner wheel. The right front wheel 103a is at a maximum outward turn angle (e.g., 86°). The front right wheel 103a rotates about a right front wheel RFA. The right and left drive wheels 104a, 104b are being driven in a forward direction, as represented by arrows 1102 and 1104, respectively. While the vehicle 100 is conducting a right turn, a projection of the right front wheel RFA and rear wheel axis RA intersect at a vertical projection intersection point IP11. While the vehicle 100 is conducting a right turn, the vehicle 100 turns around vertical projection intersection point IP11. The right front wheel 103a may follow an arched path 1110. The left front wheel 103b may follow an arched path 1112. In some embodiments, such as the embodiment shown in FIG. 10, a turn radius TR11 of vehicle 100, measured as a distance from intersection point IP11 to an outside directional control wheel (e.g., left front wheel 103b), is approximately 37 inches.

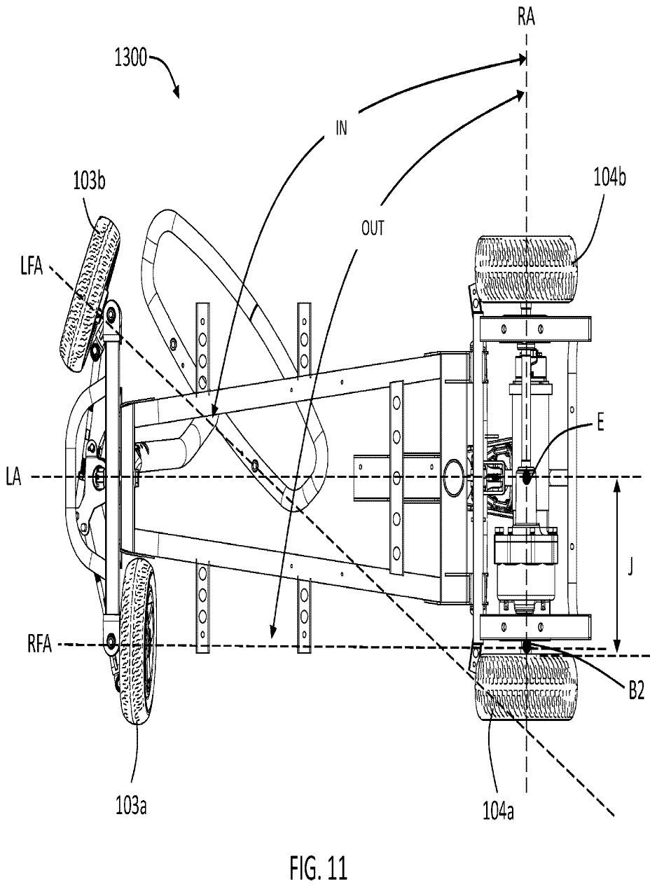

FIG. 11 illustrates a bottom view of vehicle 100 showing a relationship between a position of a pivot point of a vehicle during a major-turn, in accordance with some embodiments of the invention. In some embodiments, the position of a pivot point of vehicle 100 during a major-turn is based on the maximum outward turn angle OUT of the inside directional control wheel. In FIG. 11, the vehicle 100 is making a right turn so right front wheel 103a corresponds to the inside directional control wheel and left front wheel 103b corresponds to the outside directional control wheel. In FIG. 11, the right front wheel 103a is at a maximum outward turn angle OUT of 86° and the distance J between pivot point B2 and center point E is 188.47 mm (7.42 inches).

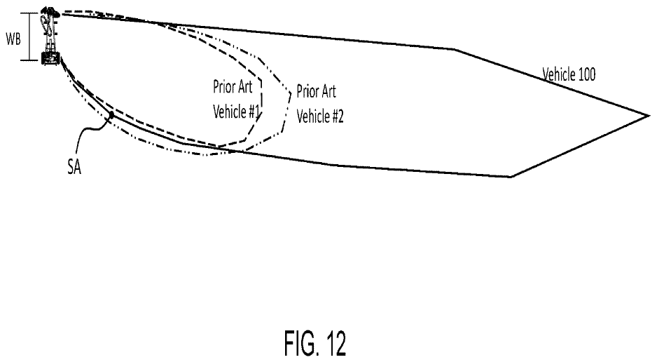

FIG. 12 illustrates a schematic representation of the points at which the right front wheel axis RFA and the left front wheel axis LFA intersect throughout a turn of the vehicle 100. Specifically, FIG. 12 illustrates the points at which the right front wheel axis RFA and the left front wheel axis LFA intersect during a right turn. Prior art vehicle #1 and prior art vehicle #2 are included for reference and show representative plots of existing vehicles. Vehicle 100 may have a wheelbase distance WB between the front and rear wheels of approximately 30.5 inches. Vehicle 100 may have a curve that is substantially larger than that of both prior art vehicle #1 and prior art vehicle #2. The area under the curve for vehicle 100 is approximately 177.62 ft². The area under the curve for prior art vehicle #1 is approximately 85 ft². The area under the curve for prior art vehicle #1 is approximately 108 ft². In some embodiments, the area under the curve of vehicle 100 may be at least 50% larger than the area under the curve for prior art vehicle #1 and prior art vehicle #2. In some embodiments, the area under the curve of vehicle 100 may be at least 40% larger than the area under the curve for prior art vehicle #1 and prior art vehicle #2. In some embodiments, the area under the curve of vehicle 100 may be at least 60% larger than the area under the curve for prior art vehicle #1 and prior art vehicle #2. The point SA at which a sensor (e.g., sensor 306) activates may be approximately 42 in. below the rear wheel axis. Further, a wheel angle measured from the longitudinal axis LA at the bottom-most point of the curve may be 35° for vehicle 100, whereas the wheel angle measured from the longitudinal axis LA at the bottom-most point of the curve may be 30° for prior art vehicle #2. We conclude that this increased area under the curve and higher angle at the bottom-most point of the curve may provide enhanced maneuverability of vehicle 100 compared to both prior art vehicle #1 and prior art vehicle #2.

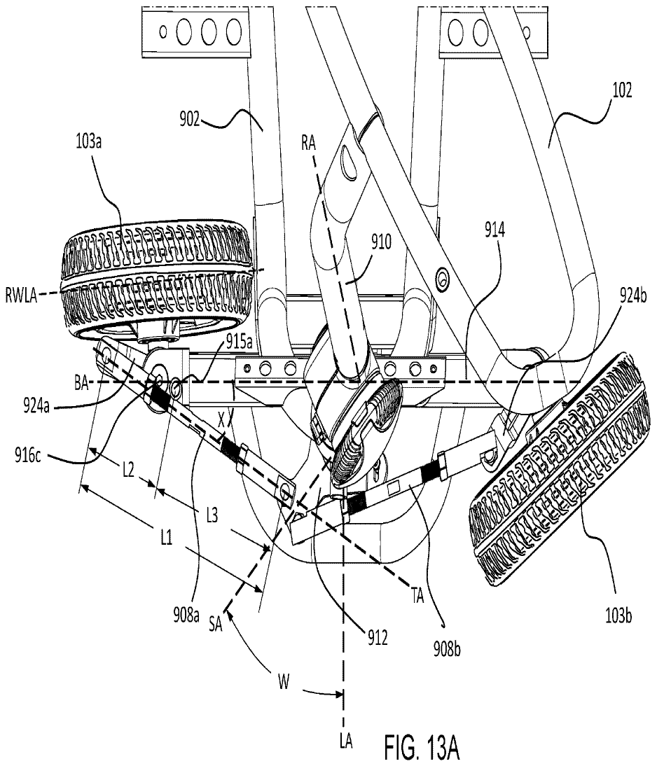

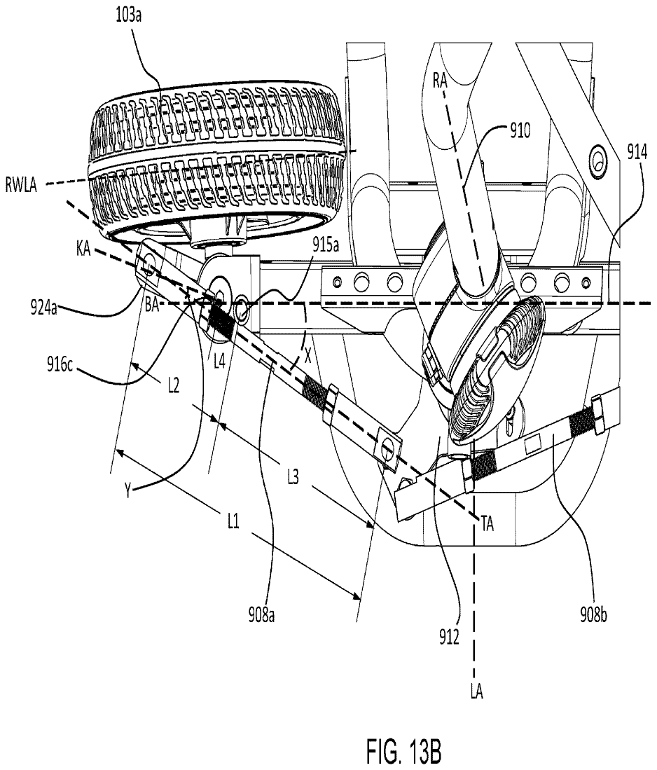

FIGS. 13A-13B illustrate an embodiment in which the right front wheel 103a is shown as the inside wheel turned to a maximum turn configuration. While the right front wheel 103a is shown as the inside wheel, it should be appreciated that the left front wheel 103b can be the inside wheel in another embodiment. In the illustrated embodiment, the right tie rod 908a is pivotably coupled to the stem tab 912 at a first end and pivotably coupled to the right steering arm 924a at a second end. The right tie rod 908a is moveable in response to movement of the steering stem 910 about the rotational axis RA. The rotation of steering stem 910 about the rotation axis RA in FIG. 13A is represented by angle W. Angle W is the angle between longitudinal axis LA and an axis SA that extends along a centerline of the stem tab 912 between tie rod connection points 960a, 960b and steering stem pivot point A.

Angle W is illustrated as approximately 52 degrees when the right front wheel 103a is in the maximum turn configuration. In some embodiments, angle W is approximately 40 degrees, approximately 42 degrees, approximately 44 degrees, approximately 46 degrees, approximately 48 degrees, approximately 50 degrees, approximately 52 degrees, approximately 54 degrees, approximately 56 degrees, approximately 58 degrees, or approximately 60 degrees when the right front wheel 103a is in the maximum turn configuration. In some embodiments, angle W is at least 40 degrees, at least 42 degrees, at least 44 degrees, at least 46 degrees, at least 48 degrees, at least 50 degrees, at least 52 degrees, at least 54 degrees, at least 56 degrees, at least 58 degrees, or at least 60 degrees when the right front wheel 103a is in the maximum turn configuration. In some embodiments, angle W is between 40 degrees and 60 degrees, between 42 degrees and 58 degrees, between 44 degrees and 56 degrees, between 46 degrees and 54 degrees or between 48 degrees and 52 degrees when the right front wheel 103a is in the maximum turn configuration.

The right tie rod 908a is illustrated in FIG. 13A as engaging the right stop 915a when the right front wheel 103a is in the maximum turn configuration. The right stop 915a is illustrated in a configuration where engagement with the right tie rod 908a prevents the right front wheel 103a from overturning or camming over. During an overturn, the camming of the right front wheel 103a may prevent or restrict a user from rotating the steering stem 910 about the rotational axis RA to come out of the turn (e.g., to align the right wheel longitudinal axis RWLA with the longitudinal axis LA of the frame 902). By stopping rotation of the right front wheel 103a before it is able to overturn, a user with limited strength can more easily control the steering assembly 202 before, during and after a turn.

The right stop 915a may be configured to engage the right tie rod 908a to prevent flexing or other deformation of the right tie rod 908a when the right front wheel 103a is in the maximum turn configuration. The tie rod 908a, illustrated in FIG. 13A has a length L1. Length L1 may be approximately 7 inches (e.g., 6.7 inches). In some embodiments, length L1 is approximately 6 inches, approximately 6.5 inches, approximately 7 inches, approximately 7.5 inches, approximately 8 inches, approximately 8.5 inches, approximately 9 inches, approximately 9.5 inches, approximately 10 inches, approximately 10.5 inches, approximately 11 inches, approximately 11.5 inches or approximately 12 inches when the right front wheel 103a is in the maximum turn configuration. In some embodiments, length L1 is at least 6 inches, at least 6.5 inches, at least 7 inches, at least 7.5 inches, at least 8 inches, at least 8.5 inches, at least 9 inches, at least 9.5 inches, at least 10 inches, at least 10.5 inches, at least 11 inches, at least 11.5 inches or at least 12 inches when the right front wheel 103a is in the maximum turn configuration. In some embodiments, length L1 is between 6 inches and 12 inches, between 6.5 inches and 11.5 inches, between 7 inches and 11 inches, between 7.5 inches and 10.5 inches, between 8 inches and 10 inches or between 8.5 inches and 9.5 inches when the right front wheel 103a is in the maximum turn configuration.

The right stop 915a may engage the right tie rod 908a at a distance L2 from the second end of the right tie rod 908a when the right front wheel 103a is in the maximum turn configuration. Distance L2 may be approximately 2.5 inches when the right front wheel 103a is in the maximum turn configuration. In some embodiments, distance L2 is approximately 1.5 inches, approximately 1.75 inches, approximately 2 inches, approximately 2.25 inches, approximately 2.5 inches, approximately 2.75 inches, approximately 3 inches, approximately 3.25 inches, approximately 3.5 inches, approximately 3.75 inches or approximately 4 inches when the right front wheel 103a is in the maximum turn configuration. In some embodiments, distance L2 is at least 1.5 inches, at least 1.75 inches, at least 2 inches, at least 2.25 inches, at least 2.5 inches, at least 2.75 inches, at least 3 inches, at least 3.25 inches, at least 3.5 inches, at least 3.75 inches or at least 4 inches when the right front wheel 103a is in the maximum turn configuration. In some embodiments, distance L2 is between 1.5 inches and 4 inches, between 1.75 inches and 3.75 inches, between 2 inches and 3.5 inches, between 2.25 inches and 3.25 inches or between 2.5 inches and 3 inches when the right front wheel 103a is in the maximum turn configuration.

The right stop 915a may engage the right tie rod 908a at a distance L3 from the first end of the right tie rod 908a when the right front wheel 103a is in the maximum turn configuration. Distance L3 may be approximately 4 inches when the right front wheel 103a is in the maximum turn configuration. In some embodiments, distance L3 is approximately 2 inches, approximately 2.5 inches, approximately 3 inches, approximately 3.5 inches, approximately 4 inches, approximately 4.5 inches, approximately 5 inches, approximately 5.5 inches, approximately 6 inches, approximately 6.5 inches, approximately 7 inches, approximately 7.5 inches, approximately 8 inches, approximately 8.5 inches, approximately 9 inches, approximately 9.5 inches or approximately 10 inches when the right front wheel 103a is in the maximum turn configuration. In some embodiments, distance L3 is at least 2 inches, at least 2.5 inches, at least 3 inches, at least 3.5 inches, at least 4 inches, at least 4.5 inches, at least 5 inches, at least 5.5 inches, at least 6 inches, at least 6.5 inches, at least 7 inches, at least 7.5 inches, at least 8 inches, at least 8.5 inches, at least 9 inches, at least 9.5 inches or at least 10 inches when the right front wheel 103a is in the maximum turn configuration. In some embodiments, distance L3 is between 2 inches and 10 inches, between 2.5 inches and 9.5 inches, between 3 inches and 9 inches, between 3.5 and 8.5 inches, between 4 inches and 8 inches, between 4.5 and 7.5 inches, between 5 inches and 7 inches or between 5.5 inches and 6.5 inches when the right front wheel 103a is in the maximum turn configuration.

In some embodiments, it has been found that right tie rod 908a may be prone to flex or deform if L3 is less than 2× the length of L2 when the right front wheel 103a is in the maximum turn configuration. In some embodiments, right tie rod 908a is prone to flex or deform if L3 is less than 2×, less than 3×, less than 4×, less than 5×, less than 6×, less than 7×, less than 8×, less than 9×, less than 10×, less than 11×or less than 12×the length of L2 when the right front wheel 103a is in the maximum turn configuration. In some embodiments, right tie rod 908a is prone to flex or deform if L3 is less than 2× to 12×, less than 3× to 11×, less than 4× to 10×, less than 5× to 9× or less than 6× to 8× the length of L2 when the right front wheel 103a is in the maximum turn configuration.

A ratio of the length of L3 to the length of L2 may be approximately 1.75:1 when the right front wheel 103a is in the maximum turn configuration. In some embodiments, the ratio of the length of L3 to the length of L2 is approximately 1:1, approximately 2:1, approximately 3:1, approximately 4:1, approximately 5:1, approximately 6:1, approximately 7:1, approximately 8:1, approximately 9:1, approximately 10:1, approximately 11:1 or approximately 12:1 when the right front wheel 103a is in the maximum turn configuration. In some embodiments, the ratio of the length of L3 to the length of L2 is at least 1:1, at least 2:1, at least 3:1, at least 4:1, at least 5:1, at least 6:1, at least 7:1, at least 8:1, at least 9:1, at least 10:1, at least 11:1 or at least 12:1 when the right front wheel 103a is in the maximum turn configuration. In some embodiments, the ratio of the length of L3 to the length of L2 is between 1:1 and 12:1, between 2:1 and 11:1, between 3:1 and 10:1, between 4:1 and 9:1, between 5:1 and 8:1 or between 6:1 and 7:1 when the right front wheel 103a is in the maximum turn configuration.

FIGS. 13A-13B illustrate an axle beam 914 that includes an axle beam axis BA extending along its length. The axle beam axis BA may extend generally perpendicular to the longitudinal axis LA of the frame 902. The axle beam axis BA is shown in the embodiment of FIG. 13A extending through the right kingpin axis 916a and left kingpin axis 916b. The right tie rod 908a includes a tie rod axis TA extending along tie rod length L1. The axle beam axis BA and the tie rod axis TA may intersect and form an angle X when the right front wheel 103a is in the maximum turn configuration. The right stop 915a may be located between the axle beam axis BA and the tie rod axis TA so as to prevent the tie rod axis TA from passing the right kingpin axis 916c during rotation of the steering stem 910. The right stop 915a may be located within angle X.

Angle X in FIG. 13A is approximately 22 degrees when the right front wheel 103a is in the maximum turn configuration. In some embodiments, angle X is approximately 10 degrees, approximately 11 degrees, approximately 12 degrees, approximately 13 degrees, approximately 14 degrees, approximately 15 degrees, approximately 16 degrees, approximately 17 degrees, approximately 18 degrees, approximately 19 degrees, approximately 20 degrees, approximately 21 degrees, approximately 22 degrees, approximately 23 degrees, approximately 24 degrees, approximately 25 degrees, approximately 26 degrees, approximately 27 degrees, approximately 28 degrees, approximately 29 degrees, approximately 30 degrees, approximately 31 degrees, approximately 32 degrees, approximately 33 degrees, approximately 34 degrees or approximately 35 degrees when the right front wheel 103a is in the maximum turn configuration. In some embodiments, angle X is at least 10 degrees, at least 11 degrees, at least 12 degrees, at least 13 degrees, at least 14 degrees, at least 15 degrees, at least 16 degrees, at least 17 degrees, at least 18 degrees, at least 19 degrees, at least 20 degrees, at least 21 degrees, at least 22 degrees, at least 23 degrees, at least 24 degrees, at least 25 degrees, at least 26 degrees, at least 27 degrees, at least 28 degrees, at least 29 degrees, at least 30 degrees, at least 31 degrees, at least 32 degrees, at least 33 degrees, at least 34 degrees or at least 35 degrees when the right front wheel 103a is in the maximum turn configuration. In some embodiments, angle X is between 10 degrees and 35 degrees, between 11 degrees and 34 degrees, between 12 degrees and 33 degrees, between 13 degrees and 32 degrees, between 14 degrees and 31 degrees, between 15 degrees and 30 degrees, between 16 degrees and 29 degrees, between 17 degrees and 28 degrees, between 18 degrees and 27 degrees, between 19 degrees and 26 degrees, between 20 degrees and 25 degrees, between 21 degrees and 24 degrees or between 22 degrees and 23 degrees when the right front wheel 103a is in the maximum turn configuration.

The right stop 915a may be located a distance L4 apart from the right kingpin 916a. Distance L4 may be approximately 0.58 inches. In some embodiments, distance L4 is approximately 0.05 inches, approximately 0.1 inches, approximately 0.15 inches, approximately 0.2 inches, approximately 0.25 inches, approximately 0.3 inches, approximately 0.35 inches, approximately 0.4 inches, approximately 0.45 inches, approximately 0.5 inches, approximately 0.55 inches, approximately 0.6 inches, approximately 0.65 inches or approximately 0.7 inches. In some embodiments, distance L4 is less than 0.05 inches, less than 0.1 inches, less than 0.15 inches, less than 0.2 inches, less than 0.25 inches, less than 0.3 inches, less than 0.35 inches, less than 0.4 inches, less than 0.45 inches, less than 0.5 inches, less than 0.55 inches, less than 0.6 inches, less than 0.65 inches or less than 0.7 inches. In some embodiments, the right stop 915a is disposed on the right kingpin 916a (e.g., such that right stop axis and right kingpin axis are co-axial). In some embodiments, the right stop 915a is integrally formed on the right kingpin 916a. In some embodiments, the right stop 915a is an extension of the right kingpin 916a along the right kingpin axis 916c.

Referring to FIG. 13B, an angle Y may be formed between the tie rod axis TA and an axis KA extending between the right kingpin 916a and the tie rod connection point 962 of the right steering arm 924a. Angle Y may be determined by the position of the right stop 915a relative to the right kingpin 916a. The right stop 915a may ensure angle Y is greater than 0 degrees. Angle Y being greater than 0 degrees may help prevent the right front wheel 103a from overturning or camming when the right front wheel 103a is in the maximum turn configuration. In some embodiments, angle Y is 0 degrees.

Angle Y may be approximately 5 degrees when the right front wheel 103a is in the maximum turn configuration. In some embodiments, angle Y is approximately 0 degrees, approximately 1 degree, approximately 2 degrees, approximately 3 degrees, approximately 4 degrees, approximately 5 degrees, approximately 6 degrees, approximately 7 degrees, approximately 8 degrees, approximately 9 degrees, approximately 10 degrees, approximately 11 degrees, approximately 12 degrees, approximately 13 degrees, approximately 14 degrees or approximately 15 degrees when the right front wheel 103a is in the maximum turn configuration. In some embodiments, angle Y is less than 1 degree, less than 2 degrees, less than 3 degrees, less than 4 degrees, less than 5 degrees, less than 6 degrees, less than 7 degrees, less than 8 degrees, less than 9 degrees, less than 10 degrees, less than 11 degrees, less than 12 degrees, less than 13 degrees, less than 14 degrees or less than 15 degrees when the right front wheel 103a is in the maximum turn configuration. In some embodiments, angle Y is between 0 degrees and 15 degrees, between 1 degree and 14 degrees, between 2 degrees and 13 degrees, between 3 degrees and 12 degrees, between 4 degrees and 11 degrees, between 5 degrees and 10 degrees, between 6 degrees and 9 degrees or between 7 degrees and 8 degrees when the right front wheel 103a is in the maximum turn configuration.

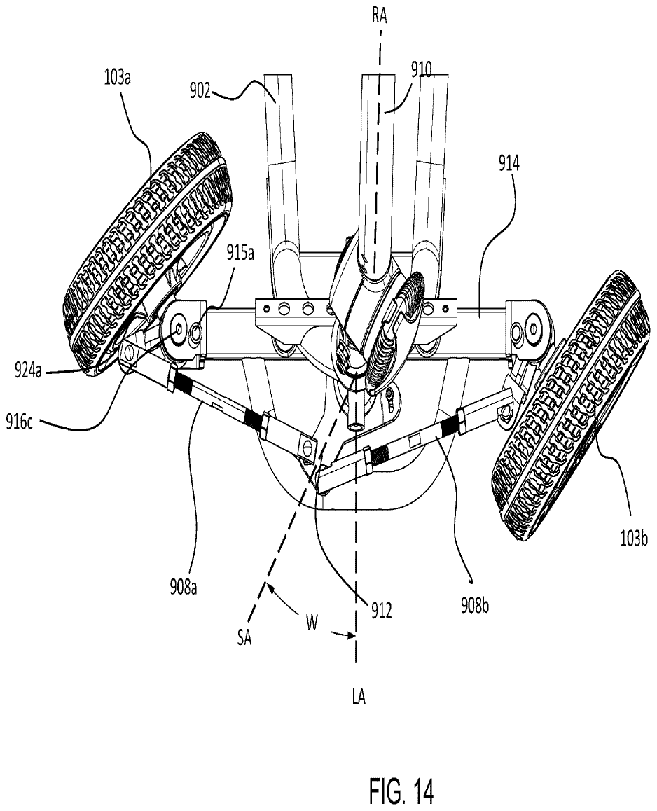

As discussed above, the sensor 306 may activate when the steering input 102 is turned through a predetermined angle (e.g., about 30 degrees) about the rotational axis RA. FIG. 14 illustrates the steering input 102 turned about the rotational axis RA an angle W. Angle W in FIG. 14 may be approximately the angle at which sensor 306 is activated (e.g., approximately 30 degrees) . A difference between angle W when the sensor 306 is activated and angle W when the right tie rod 908a engages the right stop 915a may be approximately 20 degrees. In some embodiments, the difference between angle W when the sensor 306 is activated and angle W when the right tie rod 908a engages the right stop 915a is approximately 5 degrees, approximately 6 degrees, approximately 7 degrees, approximately 8 degrees, approximately 9 degrees, approximately 10 degrees, approximately 11 degrees, approximately 12 degrees, approximately 13 degrees, approximately 14 degrees, approximately 15 degrees, approximately 16 degrees, approximately 17 degrees, approximately 18 degrees, approximately 19 degrees, approximately 20 degrees, approximately 21 degrees, approximately 22 degrees, approximately 23 degrees, approximately 24 degrees or approximately 25 degrees. In some embodiments, the difference between angle W when the sensor 306 is activated and angle W when the right tie rod 908a engages the right stop 915a is at least 5 degrees, at least 6 degrees, at least 7 degrees, at least 8 degrees, at least 9 degrees, at least 10 degrees, at least 11 degrees, at least 12 degrees, at least 13 degrees, at least 14 degrees, at least 15 degrees, at least 16 degrees, at least 17 degrees, at least 18 degrees, at least 19 degrees, at least 20 degrees, at least 21 degrees, at least 22 degrees, at least 23 degrees, at least 24 degrees or at least 25 degrees. In some embodiments, the difference between angle W when the sensor 306 is activated and angle W when the right tie rod 908a engages the right stop 915a is between 5 degrees and 25 degrees, between 6 degrees and 24 degrees, between 7 degrees and 23 degrees, between 8 degrees and 22 degrees, between 9 degrees and 21 degrees, between 10 degrees and 20 degrees, between 11 degrees and 19 degrees, between 12 degrees and 18 degrees, between 13 degrees and 17 degreesor between 14 degrees and 16 degrees.

In at least one embodiment, there is included one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

What is claimed is:

1. A personal mobility vehicle, comprising:
a frame having a longitudinal axis;
a drive wheel rotatably coupled to the frame about a drive axle;
a drive motor coupled to the frame and the drive wheel;
a controller configured to cause the drive motor to drive the drive wheel; and
a steering assembly, coupled to the frame, the steering assembly including:
a wheel having a rotation axis and a pivot axis;
a pivotable steering input configured to pivot the wheel about the pivot axis;
a steering position sensor configured to detect a pivot position of the steering input relative to the frame; and
a kingpin coupled to the frame, the kingpin having a kingpin axis at a camber angle of approximately 4 degrees and a spindle along the rotation axis at a caster angle of approximately 5 degrees,
wherein the personal mobility vehicle is configured to produce a front axle rear axle axis trace area of approximately 177.62 ft².

2. The personal mobility vehicle of claim 1 wherein a wheelbase is less than 3 feet.

3. The personal mobility vehicle of claim 1 wherein the steering assembly further comprises:
a single hall effect sensor; and
a left target and a right target configured to be sensed by the hall effect sensor to indicate that steering input has attained an angle relative to the longitudinal axis of about 35 degrees.

4. The personal mobility vehicle of claim 1 wherein the controller is configured cause the drive motor to rotate the drive wheel at a maximum speed only when the steering input is positioned at an angle of less than 35 degrees off the longitudinal axis.

5. The personal mobility vehicle of claim 1 wherein the controller is configured cause the drive motor to restrict rotation of the drive wheel to less than a maximum speed when the steering input is positioned in at an angle of at least 35 degrees off the longitudinal axis.

6. The personal mobility vehicle of claim 1 wherein the steering assembly includes a steering stem rotatable about a steering axis, the steering stem including two spaced apart targets separately detectable by a sensor coupled to the frame based on a rotation position of the steering stem.

7. The personal mobility vehicle of claim 1, wherein the wheel is rotatable about an axle disposed along the rotation axis that is fixed relative to a steering arm projecting from the kingpin, the steering arm and axle defining an angle of from 70 degrees to 75 degrees.

8. The personal mobility vehicle of claim 1, configured and dimensioned to produce a minimum turning radius to wheel base ratio of from 1 to 1.3.

9. The personal mobility vehicle of claim 1, wherein an intermediate maximum outward turn angle of the wheel is different from a maximum outward turn angle of the wheel by approximately 10 degrees.

10. The personal mobility vehicle of claim 1, wherein motor drives a transaxle about which the drive wheels rotate.

11. The personal mobility vehicle of claim 1 wherein the steering assembly includes two front wheels each pivotable about a respective kingpin axis and rotatable about a wheel axis and wherein a trace produced by a point of intersection of each wheel axis as the front wheels pivot about their respective kingpin axes defines the trace area.

12. The personal mobility vehicle of claim 11 wherein the trace intersects with a lowermost tangent perpendicular to the longitudinal axis at a point that is: i) at least 12 track widths from the longitudinal axis, ii) between 12 track widths and 28 track widths from the longitudinal axis; or iii) from about 30 feet to about 50 feet from the longitudinal axis.

13. The personal mobility vehicle of claim 12 wherein the drive wheel rotates about a drive wheel axis and the trace includes a sensor-on location that is approximately 42 inches below the drive wheel axis.

14. A mobility scooter comprising:
a frame;
a drive wheel coupled to the frame and rotatable about a drive wheel axis; and
a steering assembly, coupled to the frame, that includes:
a steering stem having a stem axis, the steering stem rotatable about the stem axis in response to input from a steering input;
a front inside wheel,
a steering stop, and
a tie rod, pivotably coupled to the steering stem at a first end and pivotably coupled to a steering arm at a second end, and configured to pivot in response to movement of the steering input and to engage the steering stop when the front inside wheel reaches a maximum outward turn angle to prevent said front inside wheel from being turned beyond the maximum outward turn angle,
wherein the steering stop engages the tie rod a first distance from the first end of the tie rod a second distance from the second end of the tie rod, and
wherein a ratio of the first distance to second distance is at least 1.75:1.

15. A mobility scooter comprising:
a frame;
a drive wheel coupled to the frame and rotatable about a drive wheel axis; and
a steering assembly, coupled to the frame, that includes:
a steering stem having a stem axis, the steering stem rotatable about the stem axis in response to input from a steering input;
a front inside wheel pivotable relative to the frame about a kingpin,
a steering stop, and
a tie rod, pivotably coupled to the steering stem at a first end and pivotably coupled to a steering arm at a second end, and configured to pivot in response to movement of the steering input and to engage the steering stop when the front inside wheel reaches a maximum outward turn angle to prevent said front inside wheel from being turned beyond the maximum outward turn angle,
wherein an axis of the tie rod and an axis extending from the second end of the tie rod through the kingpin forms an angle Y, and
wherein the angle Y is less than 22 degrees.

16. A mobility scooter comprising:
a frame;
a drive wheel coupled to the frame and rotatable about a drive wheel axis; and
a steering assembly, coupled to the frame, that includes:
a steering stem having a stem axis, the steering stem rotatable about the stem axis in response to input from a steering input;
a steering position sensor configured to detect a position of the steering stem when the steering stem is rotated a first angle about the stem axis;
a controller configured to process a signal from the steering sensor;
a front inside wheel pivotable relative to the frame about a kingpin;
a steering stop, and
a tie rod, pivotably coupled to the steering stem and configured to pivot in response to movement of the steering stem and to engage the steering stop when the steering stem is rotated a second angle about the stem axis to prevent said front inside wheel from being turned beyond a maximum outward turn angle,
wherein the second angle is between 5-25 degrees greater than the first angle.
